(19) United States
(12) Patent Application Publication
(10) Pub. No.: US 2008/0176622 A1
(43) Pub. Date: Jul. 24, 2008

(54) Gaming Machine and Playing Method Thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/926,954

(22) Filed: Oct. 29, 2007

Related U.S. Application Data
(60) Provisional application No. 60/881,461, filed on Jan. 22, 2007.

(51) Int. Cl. A63F 13/00

(52) U.S. Cl. 463/17

(57) ABSTRACT

In a gaming machine of the present invention, a player places a bet by operating a gaming terminal for a roulette game displayed on a roulette device, for example. A period of accepting the bet of game media on the roulette game is set according to the status of the roulette game. For example, an inappropriate period for accepting the bet on the roulette game is excluded from the accepting period. Upon completion of the accepting period, the bet operation cannot be accepted. Instead, the bet which is placed at the gaming terminal after the completion of the accepting period is accepted as the bet on the next roulette game.

### CROSS-REFERENCE TO RELATED APPLICATION

This application is based upon and claims the benefit of U.S. Provisional Patent Application Ser. No. 60/881,461, filed on Jan. 22, 2007; the entire contents of which are incorporated herein by reference for all purposes.

### BACKGROUND OF THE INVENTION

1. Field of the Invention

The present invention relates to a gaming machine with which players participate in a game displayed on a communal display by operating gaming terminals connected to the communal display, and a playing method thereof.

2. Description of Related Art

In US Patent Application Publication No. 2005/0059474, US Patent Application Publication No. 2005/0282618, and US Patent Application Publication No. 2005/0218590, a gaming machine with which players participate in a game displayed on a communal display by operating gaming terminals connected to the communal display via a network is disclosed.

In the case of such a gaming machine, the players operating gaming terminals are allowed to participate in the game at a certain stage of the game displayed on the communal display.

The present invention has an object of providing new entertainment characteristics by adding a menu which is different from a menu for participating in a game displayed on a communal display.

### SUMMARY OF THE INVENTION

A first aspect of the present invention provides a gaming machine which comprises a communal display device for displaying a game which is repeatedly executed; a gaming terminal at which game media are bet on the game; and a controller. The controller is operable to: (a) execute the game repeatedly, (b) display the game on the communal display device, (c) set a betting accepting period during which a bet of the game media on the game can be placed according to status of the game; (d) close a betting entry by the gaming terminal upon completion of the betting accepting period, (e) accept the bet which is placed at the gaming terminal before the betting entry is closed as the bet on a current game, and (f) accept the bet which is placed at the gaming terminal after the betting entry is closed as the bet on a next game.

A second aspect of the present invention provides a playing method of a gaming machine (the gaming machine executes a game repeatedly and displays the game on a communal display device) which comprises: setting a betting accepting period during which a gaming terminal accepts a bet of game media on the game according to status of the game; closing a betting entry by the gaming terminal upon completion of the betting accepting period; accepting the bet which is placed at the gaming terminal before the betting entry is closed as the bet on a current game; and accepting the bet which is placed at the gaming terminal after the betting entry is closed as the bet on a next game.

### BRIEF DESCRIPTION OF THE DRAWINGS

FIG. 1 is a diagram showing one example of an image to be displayed on a display of a gaming terminal according to an embodiment of the present invention.

FIG. 2 is a diagram showing a perspective view of a gaming terminal according to an embodiment of the present invention.

FIG. 3 is a diagram showing a perspective view of an outward appearance of a schematic configuration of a roulette game machine according to an embodiment of the present embodiment.

FIG. 4 is a diagram showing a plan view of a roulette device according to an embodiment of the present embodiment.

FIG. 5 is a diagram showing one example of control data.

FIG. 6 is a diagram showing one example of an image to be displayed on a display.

FIG. 7 is a block diagram showing an internal configuration of a roulette game machine according to an embodiment of the present embodiment.

FIG. 8 is a schematic diagram showing a memory area of a ROM of a roulette game machine according to an embodiment of the present embodiment.

FIG. 9 is a schematic diagram showing a memory area of a RAM of a roulette game machine according to an embodiment of the present embodiment.

FIG. 10 is a block diagram showing an internal configuration of a roulette device according to an embodiment of the present embodiment.

FIG. 11 is a schematic diagram showing a memory area of a ROM of a roulette device according to an embodiment of the present embodiment.

FIG. 12 is a block diagram showing an internal configuration of a gaming terminal according to an embodiment of the present embodiment.

FIG. 13 is a flow chart showing gaming processings of a server and a roulette device of a roulette game machine according to a first embodiment of the present embodiment.

FIG. 14 is a flow chart showing gaming processings of the server and the roulette device of the roulette game machine according to the first embodiment of the present embodiment.

FIG. 15 is a flow chart showing gaming processings of the server and the roulette device of the roulette game machine according to the first embodiment of the present embodiment.

FIG. 16 is a flow chart showing gaming processings of a gaming terminal of the roulette game machine according to the first embodiment of the present embodiment.

FIG. 17 is a flow chart showing a betting period confirmation processing shown in FIG. 16.

FIG. 18 is a flow chart showing a bet accepting processing shown in FIG. 16.

FIG. 19 is a flow chart showing a bet accepting processing shown in FIG. 16.

FIG. 20 is a diagram showing one example of an image to be displayed on the display.

FIG. 21 is a diagram showing one example of an image to be displayed on a display of a gaming terminal of a roulette game machine according to a second embodiment of the present invention.

FIG. 22 is a flow chart showing a bet accepting processing in a gaming processing of the gaming terminal of the roulette game machine according to the second embodiment of the present invention.

FIG. 23 is a flow chart showing a bet accepting processing in the gaming processing of the gaming terminal of the roulette game machine according to the second embodiment of the present invention.

FIG. 24 is a diagram showing one example of an image to be displayed on a display of a gaming terminal of a roulette game machine according to a third embodiment of the present invention.

FIG. 25 is a diagram showing one example of an image to be displayed on the display of the gaming terminal of the roulette game machine according to the third embodiment of the present invention.

### DETAILED DESCRIPTION OF THE EMBODIMENTS

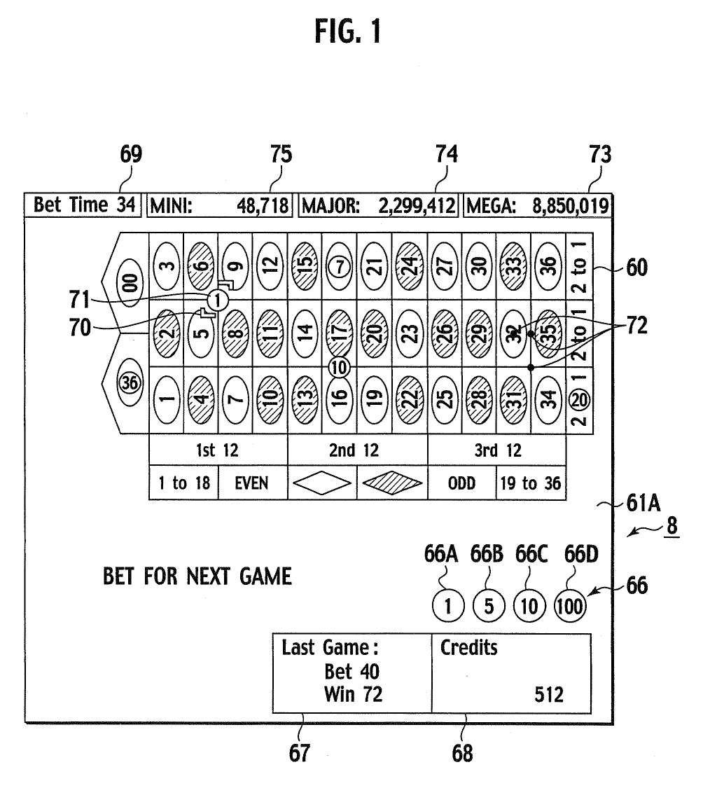

Hereinafter, a roulette game machine according to a first embodiment of the present invention will be described by referring to FIGS. 1 to 20.

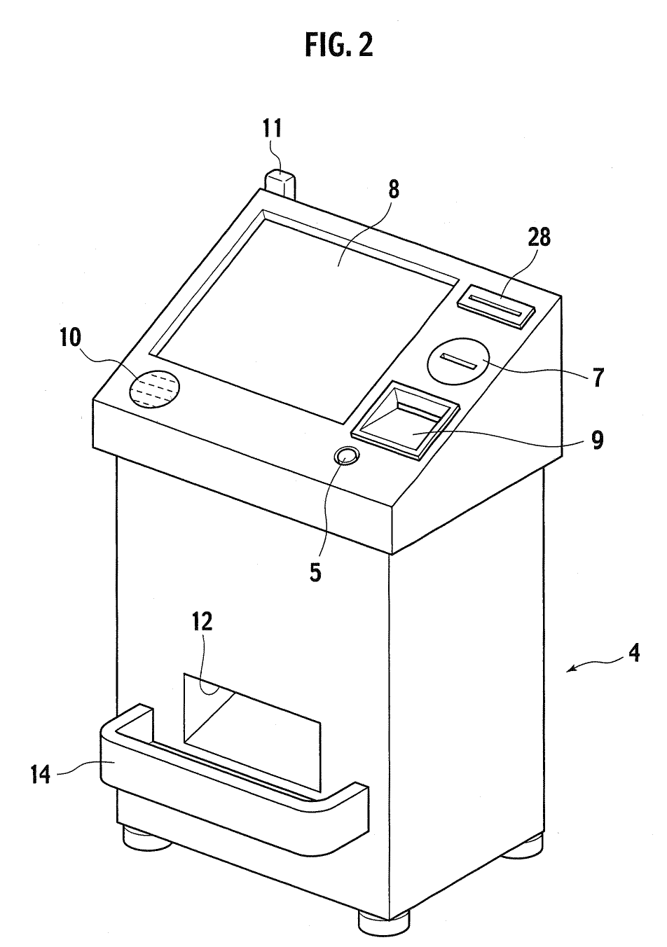

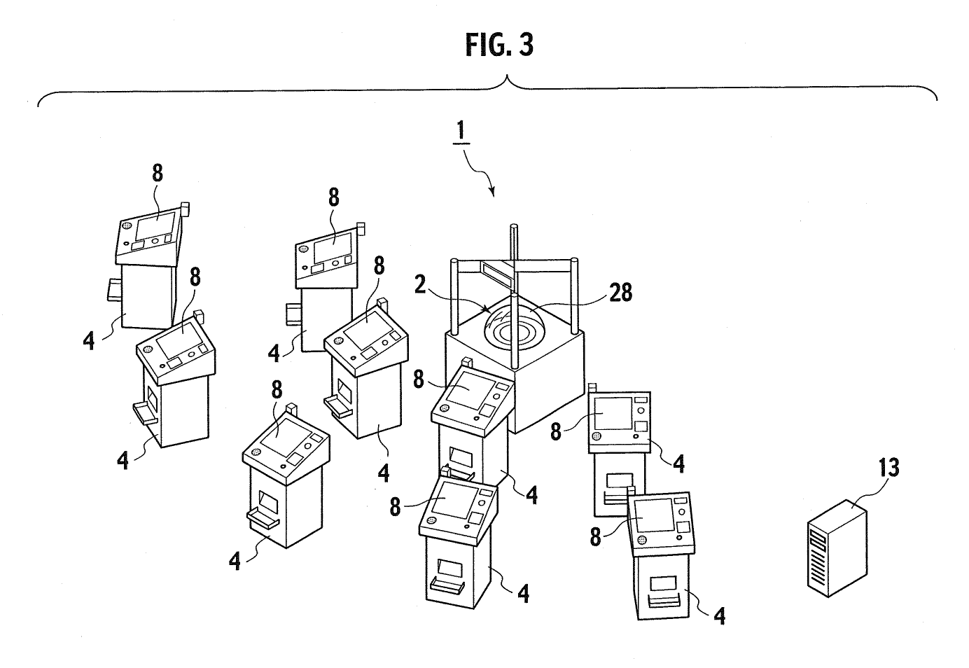

FIG. 1 is a diagram showing an example of an image to be displayed on a display provided to a gaming terminal according to the first embodiment of the present invention. FIG. 2 is a perspective view of the gaming terminal having the display in FIG. 1 according to the first embodiment of the present invention. FIG. 3 is a perspective view of an outward appearance of a schematic configuration of a roulette game machine according to an embodiment of the present invention.

The display 8 (corresponding to the display of the present invention) shown in FIG. 1 is provided on the gaming machine shown in FIG. 2. The gaming terminal 4 is provided in plurality at the roulette game machine 1 of the first embodiment shown in FIG. 3 (corresponding to the gaming machine of the present invention). Besides these, the roulette game machine 1 has a roulette device 2 (corresponding to the communal display device of the present invention) and a server 13. The gaming terminals 4, the roulette device 2 and the server 13 can be connected by a local area network or the like.

At the roulette device 2, the roulette game will be executed under the control of the server 13, and the game will be displayed to the players. The players use a plurality of gaming terminals 4 that are arranged around the roulette device 2, in order to participate in the roulette game displayed by the roulette device 2. In the present embodiment, the roulette game machine 1 has nine gaming terminals 4. Consequently, at most nine players can participate in the communal roulette game simultaneously.

The roulette game displayed on the roulette device 2 is repeatedly executed at prescribed time intervals under the control of the server 13. Accordingly, a betting period (an accepting period) when a player can place a bet for the roulette game at each of the gaming terminals 4 is limited to a certain stage in the roulette game. Upon completion of the betting period when the player can bet for the current roulette game, a bet reservation screen 61A for the next roulette game is displayed on the display 8 on each of the gaming terminals 4 as shown in FIG. 1.

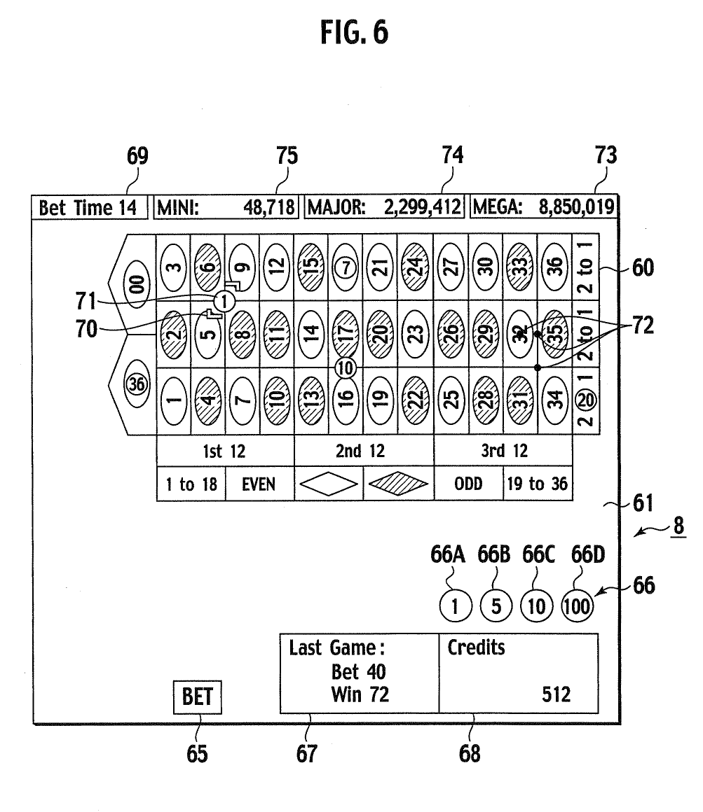

The above-described reservation screen 61A is basically the same as a bet screen 61 (see FIG. 6) displayed on the display 8 during the betting period for the current roulette game. However, a message “BET FOR NEXT GAME” is additionally displayed in the reservation screen 61A, and this message indicates that this screen is not for placing a bet on the current roulette game, but for reserving a bet on the next roulette game. Descriptions will be provided below for the communal display content between the bet screen 61 and the reservation screen 61A.

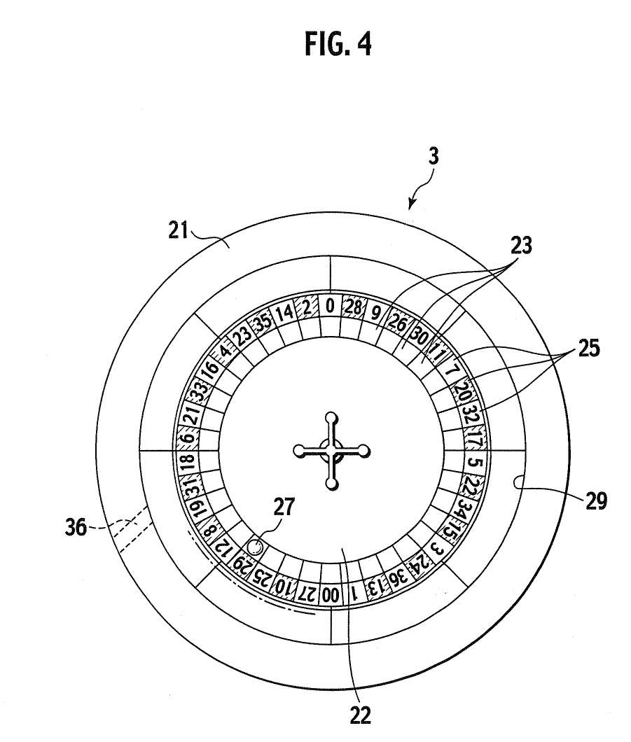

FIG. 4 is a plan view of a roulette device provided in a roulette game machine of FIG. 3.

As shown in FIG. 4, the roulette device 2 has a frame 21, and a roulette wheel 22 which is accommodated and supported rotatably inside the frame 21. On an upper surface of the roulette wheel 22, a plurality (38 in total in the present embodiment) of number pockets 23 is formed. In addition, on an upper surface of the roulette wheel 22 on an outer side of the number pockets 23, number plates 25 are provided for displaying numbers “0”, “00”, “1” to “36” in correspondence to the respective number pockets 23.

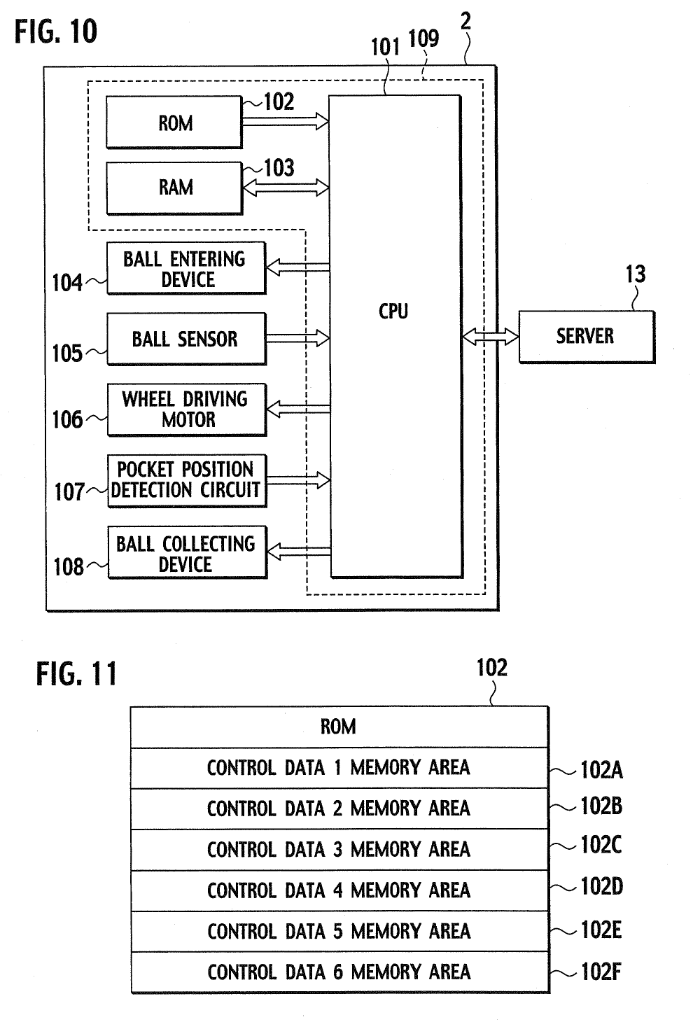

A ball entering hole 36 is opened on the inner periphery of the frame 21. The ball entering hole 36 is connected to a ball entering device 104 (see FIG. 10). In conjunction with the activation of the ball entering device 104, a ball 27 will be entered onto the roulette wheel 22 from the ball entering hole 36. Also, a hemispherical transparent acrylic cover 28 covers over the roulette device 2 (see FIG. 3).

A wheel driving motor 106 (see FIG. 10) is provided on a lower side of the roulette wheel 22. In conjunction with the activation of the wheel driving motor 106, the roulette wheel 22 will be rotated. Metal plates (not shown) are attached at prescribed intervals on a lower surface of the roulette wheel 22. As a proximity sensor of a pocket position detection circuit 107 (see FIG. 10) detects these metal plates, a position of the number pocket 23 is detected.

The frame 21 is gently inclined toward an inner side, and a guide wall 29 is formed on its middle section. The entered ball 27 is rolled by being guided by the guide wall 29 due to its centrifugal force. The ball 27 rolls down the slope of the frame 21 toward the inner side as the rotational speed decreases and the centrifugal force becomes weaker, and reaches to the rotating roulette wheel 22. Then, the ball 27 that reached to the roulette wheel 22 further falls into one of the number pockets 23 by passing over the number plates 25 on an outer side of the rotating roulette wheel 22. As a result, the number on the number plate 25 of the number pocket 23 into which the ball fell is judged by a ball sensor 105, and this number will become a winning number.

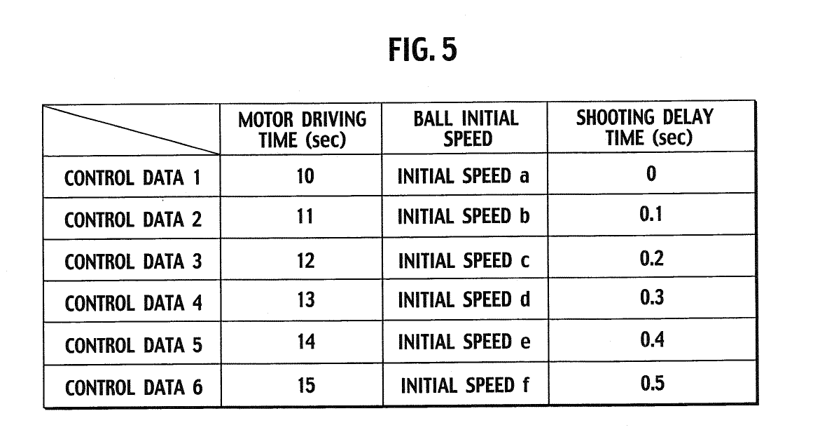

The rotation of the roulette wheel 22 and the shooting of the ball 27 are controlled according to a control data. FIG. 5 is a diagram showing an exemplary control data.

As shown in FIG. 5, six control data 1 to 6 are provided in the present embodiment. Each of the control data 1 to 6 contains a motor driving time, a ball initial speed, and a shooting delay time.

The motor driving time is a time for activating the wheel driving motor 106 (see FIG. 10). The roulette wheel 22 is rotated at a prescribed rotational speed by the wheel driving motor 106 for duration of the motor driving time. Note that after the activation of the wheel driving motor 106 is released, the rotational speed of the roulette wheel 22 will gradually decrease and come to stop eventually. The ball initial speed is an initial speed at a time of shooting the ball 27 by the ball entering device 104. The shooting delay time is a time since a prescribed number pocket 23 passes a prescribed position until the ball is shot while the roulette wheel 22 is rotated.

The control data 1 to 6, which are referred in each game at a time of controlling the rotation of the roulette wheel 22 and the shooting of the ball 27, are switched whenever a prescribed condition is met.

Here, the control data to be referred will be switched whenever it becomes a prescribed time (0-th minute of each hour, for example). In the present embodiment, the case where the control data are switched whenever it becomes a prescribed time will be described, but the prescribed condition is not limited to this case. For example, the prescribed condition can be a case where the ball 27 fell into a specific number pocket consecutively for a prescribed number of times, a case where the ball 27 fell into any of number pockets 23 of the same group (region) consecutively for a prescribed number of times, a case where a prescribed bonus (a mystery bonus or jackpot, for example) occurs, a case where the amount of chips bet on numbers belonging to a prescribed group reaches to a prescribed amount, a case where the amount of chips to be paid for the bets on numbers belonging to a prescribed group reaches to a prescribed amount, etc.

In the above described example, the case where the control data is formed by the motor driving time, the ball initial speed and the shooting delay time has been described, but the control data are not limited to this case. The control data may be data containing any of data regarding a rotation control of the roulette wheel 22 (the motor driving time), data regarding a timing for shooting the ball 27 (the shooting delay time), and data regarding an initial speed for shooting the ball 27 (the ball initial speed) or their combination. As the data regarding the rotation control of the roulette wheel 22, it is possible to use the rotation speed of the roulette wheel 22, for example, besides the motor driving time.

Next, the configuration of the gaming terminal 4 will be described.

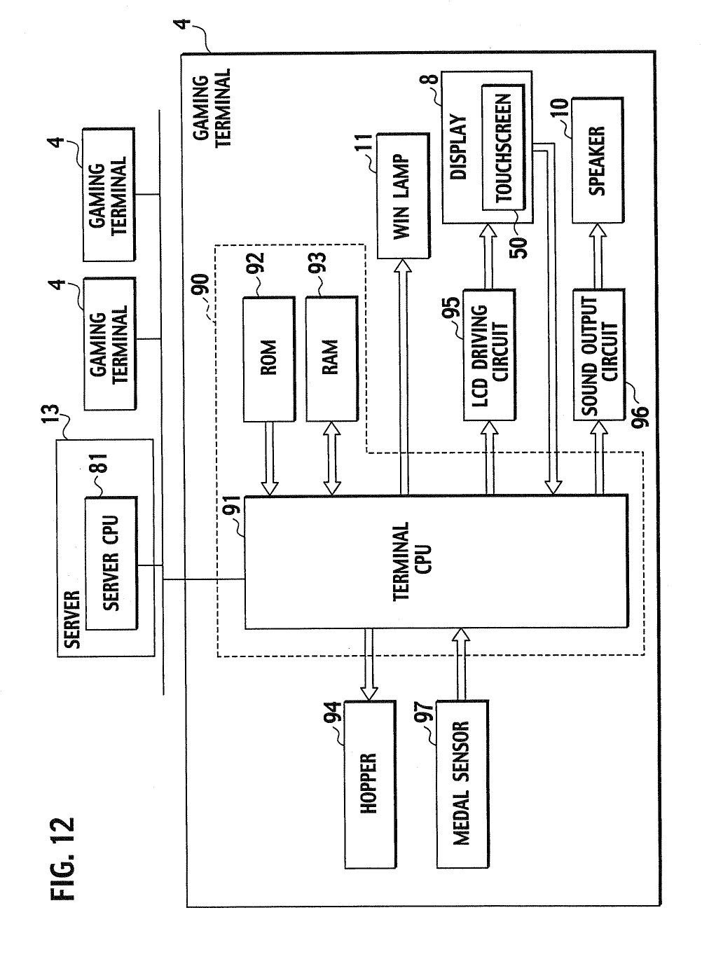

As shown in FIG. 2, the gaming terminal 4 has a medal insertion slot 7 for inserting game media (currency value: such as cash, a chip, a medal, etc.) and a above-mentioned display 8 for displaying images related to the game on its upper face. The gaming terminal 4 accepts the betting operation by the player by using the medal insertion slot 7 and the display 8. The player can play the game by operating the touchscreen 50 (see FIG. 12) or the like that is provided on a front face of the display 8 while watching the images displayed on the display 8. Note that, in the following description, the game media may be referred as their representative “medals”.

Also, besides the medal insertion slot 7 and the display 8 described above, a payout button 5, a ticket printer 6, a bill insertion slot 9, and a speaker 10 are provided on an upper face of the gaming terminal 4. A medal payout opening 12 and a medal tray 14 are provided in a front face of the gaming terminal 4.

The payout button 5 is a button for inputting a command for paying out credited medals from the medal payout opening 12 to the medal tray 14. The ticket printer 6 prints out as the bar code ticket including the data such as the credits, the date, and the identification number of the gaming terminal 4. The player can use the bar code ticket at another gaming terminal 4 and the player can bet to the game at that gaming terminal 4. Or the player can exchange the bar code ticket to bills or the like at a prescribed location (a cashier in the casino, for example) in the gaming facility.

The bill insertion slot 9 judges whether the legitimacy of the bills, and accepts the legitimate bills. Note that the bill insertion slot 9 can read the bar code ticket 39. The speaker 10 outputs music, effect sounds and the like.

On an upper side of the display 8 of each gaming terminal 4, a WIN lamp 11 is provided respectively. In the case where the number (“0”, “00” and “1” to “36” in the present embodiment) bet at the gaming terminal 4 in the game becomes the winning number, the WIN lamp 11 of the winning gaming terminal 4 will be turned on. Also, in the jackpot (referred hereafter also as JP) bonus game for obtaining JP, the WIN lamp 11 of the gaming terminal 4 that obtained JP will be turned on similarly. Note that this WIN lamp 11 provided at a position that is visible from all of the arranged gaming terminals 4 (9 sets in the present embodiment), such that the other players who are playing at the same roulette game machine 1 can always check which WIN lamp 11 is turned on.

Inside the medal insertion slot 7, a medal sensor (not shown) is provided, and it identifies the currency values such as medals that are inserted at the medal insertion slot 7, and counts the inserted medals. Also, a hopper (not shown) is provided inside the medal payout opening 12 and it pays a prescribed number of medals from the medal payout opening 12.

Note that, in the roulette game machine 1 according to the present embodiment, three types of JP including “MEGA”, “MAJOR” and “MINI” are provided. In the case of “MEGA” JP, 0.15% of the credits bet in the game at all the gaming terminals 4 will be accumulated and stored. In the case of “MAJOR” JP, 0.20% of the bet credits will be accumulated and stored. In the case of “MINI” JP, 0.30% of the bet credits will be accumulated and stored. Then, in the case where any one of JP is won in the JP bonus game to be described below, the credits that is accumulated for the corresponding JP will be paid to a prescribed gaming terminal 4. The JP amount display 15 displays the accumulated credits for “MEGA” JP among three types of JP. Note that the JP amount display 15 is provided at a top of the electroluminescence display 5, such that its display content is visible from all the players who are playing at the gaming terminals 4.

FIG. 6 shows one example of an image to be displayed on the display 8.

The bet screen 61 shown in FIG. 6 or the reservation screen 61A shown in FIG. 1 is displayed on the display 8 on each of the gaming terminals 4 according to the status of the game. The bet screen 61 is displayed during the betting period set in the server 13, and the reservation screen 61A is displayed during a period (a reservation period) from the completion of the betting period to the arrival of the next betting period. Each of the bet screen 61 and the reservation screen 61A has a betting board 60. The player can place a bet by operating a touchscreen 50 (see FIG. 12) provided on a front surface of the display 8, by using own chips (that are credited as an electronic information at the gaming terminal 4) during the betting period when the bet screen 61 (FIG. 6) is displayed on the display 8.

First, the bet screen 61 displayed on the bet screen 61 during the betting period will be described according to FIG. 6. On the betting board 60, 38 types of numbers “0”, “00” and “1” to “36” are arranged and displayed in lattice shaped grids. Also, special bet areas for betting chips by specifying “odd, even numbers”, “a color of the number plate (red or black)”, or “a range of numbers (“1” to “12”, for example)” are similarly arranged in lattice shaped grids.

On the lower side of the betting board 60, a bet confirmation button 65, bet buttons 66, a payout counter 67 and a credit counter 68 are displayed.

The bet buttons 66 are buttons for betting chips on a bet area 72 (on the grids of the numbers and the marks or on the lines forming grids) specified by the player. The bet buttons 66 comprise four types including a 1 bet button 66A, 5 bet button 66B, 10 bet button 66C, and 100 bet button 66D.

The player specifies a betting position with a cursor 70 by directly touching the bet area 72 on the display 8 by a finger or the like. By touching the 1 bet button 66A once in this state, the player can bet one chip (each time the 1 bet button 66A is touched, the number of bets increases in the order of “1”-->“2”-->“3”--> . . . ). Also, by touching the 5 bet button 66B once in this state, the player can bet five chips (each time the 5 bet button 66B is touched, the number of bets increases in the order of “5”-->“10”-->“15”--> . . . ). Also, by touching the 10 bet button 66C once in this state, the player can bet ten chips (each time the 10 bet button 66C is touched, the number of bets increases in the order of “10”-->“20”-->“30”--> . . . ). Also, by touching the 100 bet button 66D once in this state, the player can bet one hundred chips (each time the 100 bet button 66D is touched, the number of bets increases in the order of “100”-->“200”-->“300”--> . . . ).

After the above described betting operation, the betting content will be confirmed as the player touches the bet confirmation button 65. Consequently, the betting content can be corrected if it is before touching the bet confirmation button 65. Note that the bet confirmation button 65 is not provided on the reservation screen 61A (FIG. 1) displayed on the display 8 during a time period other than the betting period (i.e. during the reservation period). This is because a period when the player can confirm a betting content is limited to the betting period.

The payout counter 67 displays the number of bet chips and the payout credit in the last game. Here, the number to be obtained by subtracting the number of bet chips from the payout credit is the newly obtained credit by the player in the last game.

The credit counter 68 displays the current credits owned by the player. The credits will be decreased according to the number of bets (one credit for one bet). Also, when the payout of credits is provided by winning, the credits will be increased as much as the payout credit. Note that when the owned credit by the player becomes zero, the game is over.

Also, a bet time counter 69 is provided on the upper portion of the betting board 60. The bet time counter 69 displays a remaining time in which the players can bet. On the bet time counter 69, “20” will be displayed at the start of the betting accepting period, and this number is decremented by one per each second. The acceptance of the betting is finished when this number becomes “0”. Also, when the remaining time of the betting period becomes five seconds, the ball entering device is activated and the ball 27 is entered onto the roulette wheel 22.

Note that the screen displayed on the display 8 is switched from the bet screen 61 (FIG. 6) to the reservation screen 61A (FIG. 1) upon completion of accepting the betting operation. This reservation screen 61A is for reserving the bet for the roulette game (the next roulette game) using the ball 27 that will be entered onto the roulette wheel 22 in the next time. The betting board 60, the bet buttons 66, the payout counter 67 and the credit counter 68 are displayed on the reservation screen 61A on the display 8 similarly as the bet screen 61. “60” will be displayed on the bet time counter 69 when the screen is switched from the bet screen 61 to the reservation screen 61A. The number of the bet time counter 69 is decremented by one per second. The number of the number pockets 23 into which the ball 27 entered onto the roulette wheel 22 fallen is determined as the winning number. Thereafter, “20” will be displayed on the bet time counter 69 at the time when the current roulette game ends after the winning number has been determined. At this timing, the screen displayed on the display 8 is switched again from the reservation screen 61A (FIG. 1) to the bet screen 61 (FIG. 6). This timing of switching from the reservation screen 61A to the bet screen 61 is the ending time of the current roulette game, and also the starting time of the next roulette game.

A MEGA counter 73 displaying the number of credits accumulated for a “MEGA” JP, a MAJOR counter 74 displaying the number of credits accumulated for a “MAJOR” JP, and a MINI counter 75 displaying the number of credits accumulated for a “MINI” JP are provided at the right side of the bet time counter 69. The number obtained by accumulatively summing up 0.15% of credits bet at all the twelve gaming terminals 4 is displayed on the MEGA counter 73. The number obtained by accumulatively summing up 0.20% of the credits bet is displayed on the MAJOR counter 74. The number obtained by accumulatively summing up 0.30% of the credits bet is displayed on the MINI counter 75. The numbers displayed on the MEGA counter 73, the MAJOR counter 74 and the MINI counter 75 are shared by all the gaming terminals 4. In the case where any one of the JPs is won in the JP bonus game, a JP payout is provided according to the winning credits of the one of the JPs displayed on the respective counters 73 to 75. An initial value (200 credits for “MINI,” 5000 credits for “Major” and 50000 credits for “MEGA”) is displayed on the one of the counters 73 to 75 after the JP payout.

On the betting board 60, the cursor 70 indicative of the bet area 72 currently specified by the player is displayed. In addition, on the betting board 60, a chip mark 71 indicating the number of bet chips and the bet area 72 is displayed. The number displayed on the chip mark 71 indicates the number of the bet chips. For example, as shown in FIG. 4, the chip mark 71 of “7” placed on the grid “18” indicates that seven chips are bet on the number “18”. Incidentally, betting on only one number is called “straight bet”.

The chip mark 71 of “1” placed on the intersection point of the grids “5”, “6”, “8”, and “9” indicates that one chip is bet on the four numbers “5”, “6”, “8”, and “9”. Incidentally, such betting on four numbers is called “corner bet”.

Other betting methods include “split betting” for betting on two numbers by placing a chip on the line between the two numbers, “street bet” for betting on three numbers (for example, “13”, “14”, and “15”) by placing a chip on the end of the horizontal line (a line in the longitudinal direction in FIG. 4), “five bet” for betting on five numbers of “0”, “00”, “1”, “2”, and “3” by placing a chip on the line between the numbers “00” and 3”, “line bet” for betting on six numbers (for example, “13”, “14”, “15”, “16”, “17”, and “18”) by placing a chip between ends of two horizontal lines (two lines in the longitudinal direction in FIG. 5), “column bet” for betting on 12 numbers on the grid denoted by “2to1”, and “dozen bet” for betting on successive 12 numbers by placing a chip on the grid denoted by “1st 12”, “2nd 12” or “3rd 12”.

Furthermore, there are other betting methods using six grids provided in the lowest tier of the betting board 60, such as a method for betting on the color of the number display plate (“red” or “black”), a method for betting on odd or even numbers, and a method for betting on “1 to 18” and “19 to 36”. Here, these plural betting methods differ in the dividend of credits per chip (payout rate) when the game is won.

The player makes his/her bet as follows based on the bet screen 61 configured as described above. That is, the player first specifies a bet area 72 (a square of a number or a mark, or a line forming the square) on the screen by directly touching it with his/her finger. As a result, the cursor 70 moves to the specified bet area 72.

Subsequently, chips are bet on the specified bet area 72 when the player touches any of the bet buttons 66 (1-bet button 66A, 5-bet button 66B, 10-bet button 66C and 100-bet button 66D). For example, touching the 10-bet button 66C four times, the 5-bet button 66B once, and the 1-bet button 66A three times will result in a bet of 48 chips.

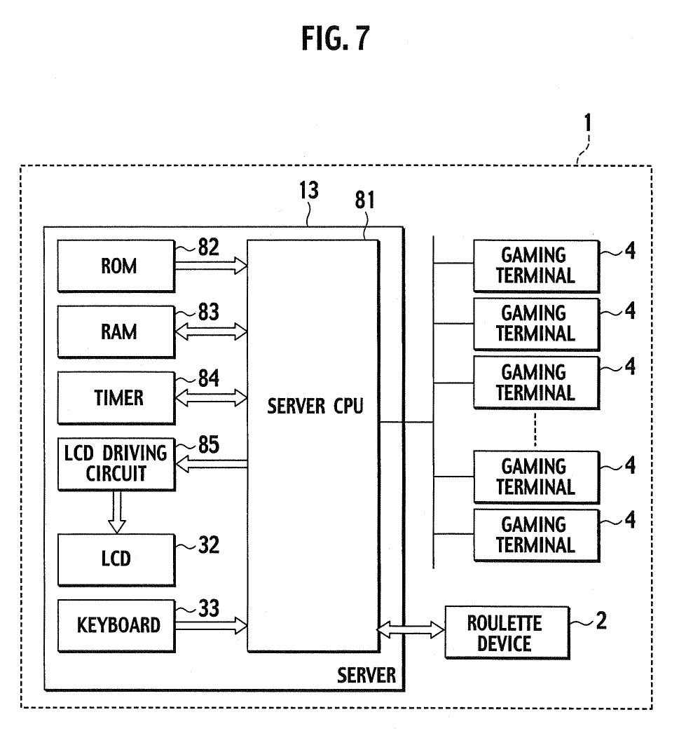

FIG. 7 is a block diagram showing an internal configuration of the roulette game machine according to the present embodiment.

As shown in FIG. 7, the roulette game machine 1 has the server 13, the roulette device 2 and a plurality (9 sets in the present embodiment) of the gaming terminals 4. The roulette device 2 and the gaming terminals 4 are connected to the server 13. Note that an internal configuration of the roulette device 2 and an internal configuration of the gaming terminal 4 will be described below in detail.

The server 13 has a server CPU 81 for executing the overall control, a ROM 82, a RAM 83, a timer 84, a LCD (Liquid Crystal Display) 32 connected through a LCD driving circuit 85, and a keyboard 33.

The server CPU 81 carries out various processings according to input signals supplied from each gaming terminals 4, and data & programs stored in the ROM 82 & the RAM 83. Also, the server CPU 81 transmits command signals to the gaming terminals 4 according to the processing results, to control each gaming terminal 4 by its initiative. Also, the server CPU 81 transmits control signals to the roulette device 2, to control the shooting of the ball 27 and the rotation of the roulette wheel 22.

The ROM 82 is formed by a semiconductor memory or the like and stores programs that implement basic functions of the roulette game machine 1, programs that execute the notification of the maintenance time and the setting & management of the notification condition, the payout rate data for the roulette game (the payout credits with respect to the win per one chip), programs for controlling each gaming terminal 4, etc.

On the other hand, the RAM 83 temporarily stores the betting information supplied from each gaming terminal 4, the winning number of the roulette device 2 detected by the sensors, the accumulated JP credits, the data regarding the result of the processing executed by the server CPU 81, etc.

In addition, the timer 84 is connected to the server CPU 81. The time information of the timer 84 is transmitted to the server CPU 81. The server CPU 81 executes the control of the rotation of the roulette wheel 22 and the shooting of the ball 27 based on the time information of the timer 84.

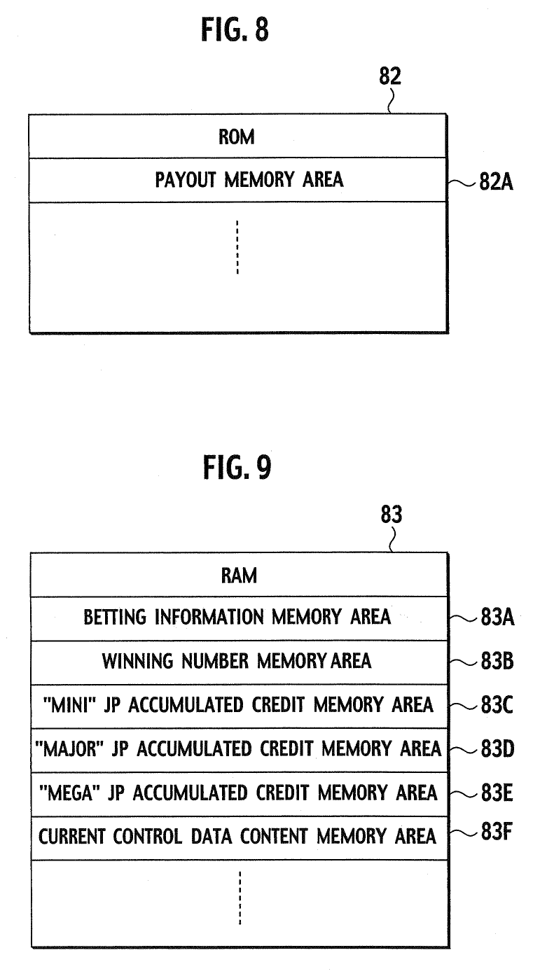

FIG. 8 is a schematic diagram showing the memory region of the ROM of the roulette game machine according to the present embodiment.

As shown in FIG. 8, a game payout memory area 82A is secured in the ROM 82. The game payout memory area 82A stores the payout rates regarding the roulette game. Note that the payout rates with respect to each bet area 72 stored in the game payout memory area 82A are determined previously as rates of “×2” to “×36” depending on the types of the betting (“straight bet”, “cornet bet”, “split bet”, etc.).

FIG. 9 is a schematic diagram showing the memory region of the RAM of the roulette game machine according to the present embodiment.

As shown in FIG. 9, a betting information memory area 83A, a winning number memory area 83B, a “MINI” JP credit memory area 83C, a “MAJOR” JP credit memory area 83D, a “MEGA” JP credit memory area 83E are secured in the RAM 83. The betting information memory area 83A stores the betting information of the currently playing players. Note that the betting information is information regarding the betting such as the specified bet area 72 (see FIG. 6), the number of bet chips (the number of bets), and the types of betting. The winning number memory area 83B stores the winning number of the roulette device 2 detected by the ball sensor 105. The “MINI” JP credit memory area 83C stores the number of credits accumulated for the “MINI”JP. The “MAJOR” JP credit memory area 83D stores the number of credits accumulated for the “MAJOR” JP. The “MEGA” JP credit memory area 83E stores the number of credits accumulated for the “MEGA” JP.

FIG. 10 is a block diagram showing an internal configuration of the roulette device according to the present embodiment.

As shown in FIG. 10, the roulette device 2 has a controller 109, the pocket position detection circuit 107, the ball entering device 104, the ball sensor 105, the wheel driving motor 106, and a ball collecting device 108. The controller 109 corresponds to the controller of the present invention.

The controller 109 has a CPU 101, a ROM 102, and a RAM 103. The CPU 101 controls the shooting of the ball 27 and the rotation of the roulette wheel 22 according to the control signals supplied from the server 13, and data & programs stored in the ROM 102 & the RAM 103. In the RAM 103, one of the control data 1 to 6 in the ROM 102 that is to be referred at a time of rotating the roulette wheel 22 and shooting the ball 27 is stored.

FIG. 11 is a schematic diagram showing a memory region of the ROM of the roulette device according to the present embodiment.

As shown in FIG. 11, in the ROM 102, the control data memory areas 102A to 102F are secured, and the control data 1 to 6 shown in FIG. 5 are stored. Also, in the ROM 102, default control data to be referred at a time of the rotation of the roulette wheel 22 and the shooting of the ball 27 immediately after the activation of the roulette game machine 1 are stored.

The pocket position detection circuit 107 has a proximity sensor. It detects the rotation position of the roulette wheel 22 by detecting metal plates attached to the roulette wheel 22.

The ball entering device 104 is for entering the ball 27 onto the roulette wheel 22 from the ball entering hole 36 (see FIG. 4). The ball entering device 104 shoots the ball 27 at the initial speed set in the control data. Also, the ball entering device 104 shoots the ball 27 at a timing according to the shooting delay time set in the control data. Namely, after the shooting delay time has elapsed since it is detected that a prescribed number pocket 23 (“00”, for example) has passed a prescribed position (in front of the ball entering hole 36, for example) by the pocket position detection circuit 107, the ball 27 will be shot.

The ball sensor 105 is a device for detecting the number pocket 23 into which the ball 27 fell. The wheel driving motor 106 is for rotating the roulette wheel 22. The wheel driving motor 106 stops the activation after the motor driving time that is set in the control data has elapsed since the start of the activation. The ball collecting device 108 is for collecting the ball 27 on the roulette wheel 22 after the game is over.

FIG. 12 is a block diagram showing an internal configuration of the gaming terminal according to the present embodiment. Note that 9 sets of the gaming terminals 4 have basically the same configuration, and an example of one gaming terminal 4 will be described in the following.

As shown in FIG. 12, the gaming terminal 4 has a terminal controller 90 formed by a terminal CPU 91, a ROM 92 and a RAM 93. The ROM 92 is formed by a semiconductor memory or the like and stores programs that implement basic functions of the gaming terminal 4, and various programs, data table, etc., that are necessary for controlling the gaming terminal 4. Also, the RAM 93 is a memory for temporarily storing various data calculated by the terminal CPU 91, the owned credits by the player (deposited at the gaming terminal 4), the state of betting by the player, a flag F for indicating that it is under the betting period or not, etc.

To the terminal CPU 91, a payout button 5 is connected. The payout button 5 is a button to be pressed by the player usually when the game is over. When the payout button 5 is pressed by the player, the medals according to the credits acquired in the game by the player will be paid from the medal payout opening 12 (usually one medal for one credit).

The terminal CPU 91 executes various corresponding operations according to the operation signals outputted by the payout button 5 as a result of pressing of the payout button 5. More specifically, the terminal CPU 91 executes various processings when signals associated with the pressing of the bet confirmation button 65 is inputted, according to the input signals and data & programs stored in the ROM 92 & the RAM 93. The terminal CPU 91 transmits their processing results to the server CPU 81.

Also, the terminal CPU 91 receives command signals from the sever CPU 81 and controls peripheral devices constituting the gaming terminal 4, so as to proceed with the game. Also, the terminal CPU 91 executes various processings according to the above described input signals and data & programs stored in the ROM 92 & the RAM 93, depending on the processing contents. The terminal CPU 91 controls the peripheral devices constituting the gaming terminal 4 according to the processing results, so as to proceed with the game.

Also, a hopper 94 is connected to the terminal CPU 91. The hopper 94 pays a prescribed number of medals from the medal payout opening 12 (see FIG. 2) according to a command signal from the terminal CPU 91.

In addition, the display 8 is connected to the terminal CPU 91 through a LCD driving circuit 95. The LCD driving circuit 95 has a program ROM, an image ROM, an image control CPU, a work RAM, VDP (Video Display Processor), and a video RAM. The program ROM stores an image controlling program and various selection tables regarding the display at the display 8. The image ROM stores dot data for forming an image to be displayed at the display 8, for example. The image control CPU makes the determination of an image to be displayed at the display 8 from the dot data in the image ROM, according to the image control program in the program ROM, based on parameters set up by the terminal CPU 91. The work RAM is provided as a temporary memory device at a time of executing the image control program at the image control CPU. The VDP forms a display image determined by the image control CPU and outputs it to the display 8. Note that the video RAM is provided as a temporary memory device at a time of forming an image by the VDP.

Also, the touchscreen 50 is attached on the front surface of the display 8. The operation information of the touchscreen 50 is transmitted to the terminal CPU 91. At the touchscreen 50, the betting operation by the player is carried out on the bet screen 61. More specifically, the operation of the touchscreen 50 is carried out for the selection of the bet area 72 and the input via the bet buttons 66 and the bet confirmation button 65, etc. When the touchscreen 50 is operated, its operation information is transmitted to the terminal CPU 91. Then, according to that information, the betting information (the bet area and the number of bets specified on the bet screen 61) is stored into the RAM 93. In addition, this betting information is transmitted to the server CPU 81, and stored in the betting information memory area of the RAM 83.

In addition, a sound output circuit 96 and a speaker 10 are connected to the terminal CPU 91. The speaker 10 generates various effect sounds at a time of making various effects according to the output signals from the sound output circuit 96.

Also, a medal sensor 97 is connected to the terminal CPU 91. The medal sensor 97 detects medals inserted from the medal insertion slot 7 (see FIG. 2). At the same time, the medal sensor 97 counts the inserted medals, and transmits its result to the terminal CPU 91. The terminal CPU 91 increases the amount of credits of the player that is stored in the RAM 93 according to the transmitted signal.

Also, a WIN lamp 11 is connected to the terminal CPU 91. The terminal CPU 91 turns on the WIN lamp 11 in a prescribed color, when the bet on the bet screen 61 won or when the JP is won.

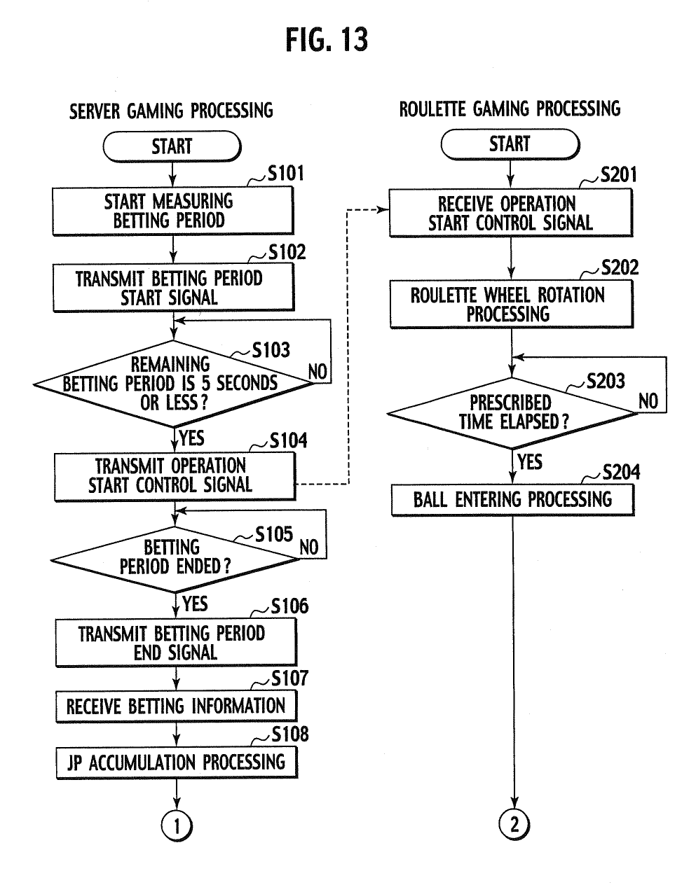

Hereinafter, with reference to FIGS. 13 to 15, descriptions will be provided for a server gaming processing and a roulette gaming processing in the roulette game machine 1 according to the present embodiment. Here, the server gaming processing is executed by the server CPU 81 of the server 13 in accordance with programs stored in the ROM 82, and the roulette gaming processing is executed by the CPU 101 of the roulette device 2 in accordance with programs stored in the ROM 102. FIGS. 13 to 15 are flow charts showing the gaming processings of the server 13 and the roulette device 2 in the roulette game machine 1 according to the present embodiment.

Firstly, the gaming processing of the server 13 will be described referring to FIGS. 13 to 15.

As shown in FIG. 13, the server CPU 81 starts the measurement of the betting period first (step S101). The betting period is a period when the bet can be placed. The player participating in the game can place a bet on the bet area 72 predicted by himself, by operating the touchscreen 50 during the betting period. When the measurement of the betting period is started, the server CPU 81 transmits a betting period start signal to the terminal CPU 91 (step S102).

Next, the server CPU 81 judges whether the remaining betting period has become 5 seconds or less (step S103). The remaining betting period is displayed on the bet time counter 69 of the display 8 at each of the gaming terminals 4 (see FIG. 6). In the case where it is judged that it has not reached the last 5 seconds, the processing will be returned to the step S103. On the other hand, in the case where it is judged that it has reached the last 5 seconds, the processing will move to the step S104.

The server CPU 81 transmits the control signal for starting the operation of the roulette device 2 to the CPU 101 (step S104). After that, the server CPU 81 judges whether the betting period of the roulette game has ended or not (step S105). In the case where it is judged that the betting period has not ended, the server CPU 81 suspends the processing until the betting period ends. On the other hand, in the case where it is judged that the betting period of the roulette game has ended, the server CPU 81 transmits a betting period end signal to the terminal CPU 91 (step S106).

Subsequently, the server CPU 81 receives the betting information (the specified bet area 72, the number of bet chips, and the type of betting) at each gaming terminal 4 from the terminal CPU 91, and stores it into the betting information memory area 83A of the RAM 83 (step S107).

After that, the server CPU 81 executes a JP accumulation processing (step S108). In this JP accumulation processing, 0.30% of the total credits which have been bet at all the gaming terminals 4 that are received at the step S107 are accumulatively added to the JP credits stored in the “MINI” JP accumulated memory area 83C in the RAM 83. Moreover, 0.20% of the total credits are accumulatively added to the JP credits stored in the “MAJOR” JP credit memory area 83D in the RAM 83. In addition, 0.15% of the total credits are accumulatively added to the JP credits stored in the “MEGA” JP credit memory area 83E in the RAM 83. Furthermore, the displays on the JP amount display 15, the MEGA counter 73, the MAJOR counter 74 and the MINI counter 75 are updated according to the JP credits thus accumulatively added.

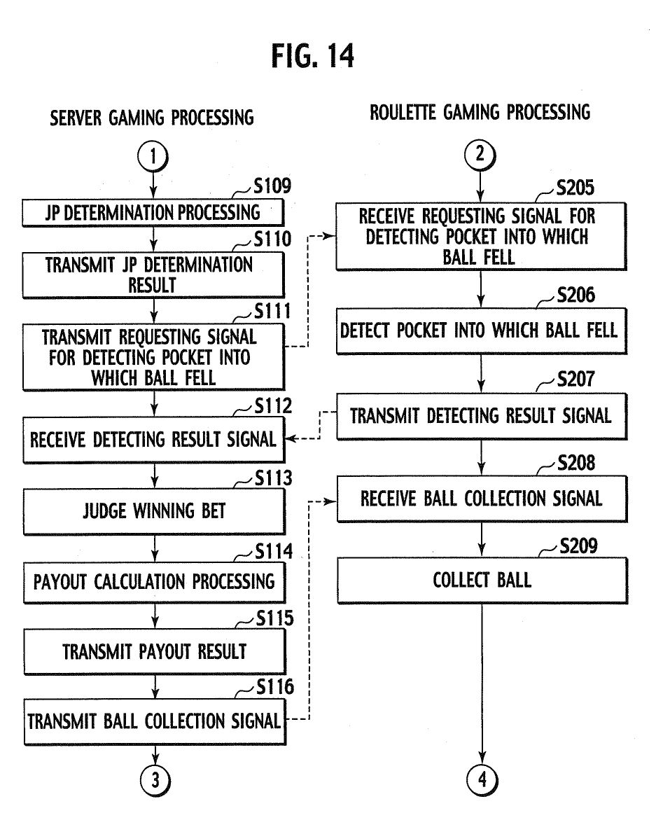

Next, as shown in FIG. 14, the server CPU 81 executes a JP determination processing (step S109). In this processing, the server CPU 81 determines whether to execute the JP bonus game at each gaming terminal 4 or not, by using a random number value sampled by a sampling circuit or the like. In addition, the server CPU 81 determines which gaming terminal 4 is to win the JP (or all the gaming terminals 4 are to lose) in the case where it is determined to execute the JP bonus game. Also, the server CPU 81 determines which JP (“MEGA”, “MAJOR” or “MINI”) is to be won in the case of having the JP won.

Next, the server CPU 81 transmits the JP bonus game determination result to each gaming terminal 4, according to the processing of the step S109 (step S110). After that, the server CPU 81 transmits a control signal to the CPU 101 of the roulette device 2, and thereby causes the CPU 101 to judge into which number pocket 23 the ball 27 has fallen (step S111). Then, the server CPU 81 receives a detection signal of the number pocket 23 into which the ball 27 has fallen from the CPU 101 (step S112).

Thereafter, the server CPU 81 judges whether the bet placed at each gaming terminal 4 has won or not, based on the betting information of each gaming terminal 4 received at the step S107 and the detection signal of the number pocket 23 received at the step S112 (step S113).

After that, the server CPU 81 executes the payout calculation processing (step S114). In the payout calculation processing, the server CPU 81 firstly recognizes the number of winning bets on the winning number for each gaming terminal 4. Then, the server CPU 81 calculates the total payout credits for each gaming terminal 4 by using the payout rate (credits to be paid per one bet) that is stored in the payout memory area 82A of the ROM 82.

Next, the server CPU 81 executes the transmission processing of the credit payout result according to the payout calculation processing of the step S113 and the JP payout determination processing of the step S109 (step S115). More specifically, the server CPU 81 outputs the credit data corresponding to the payout credits for the game to the terminal CPU 91 of the winning gaming terminal 4. Moreover, the server CPU 81 additionally outputs the credit data corresponding to the accumulated JP credits in the case where the JP has been won. After that, the server CPU 81 transmits a request signal for collecting the ball 27 on the roulette wheel 22 to the CPU 101 of the roulette device 2 (step S116).

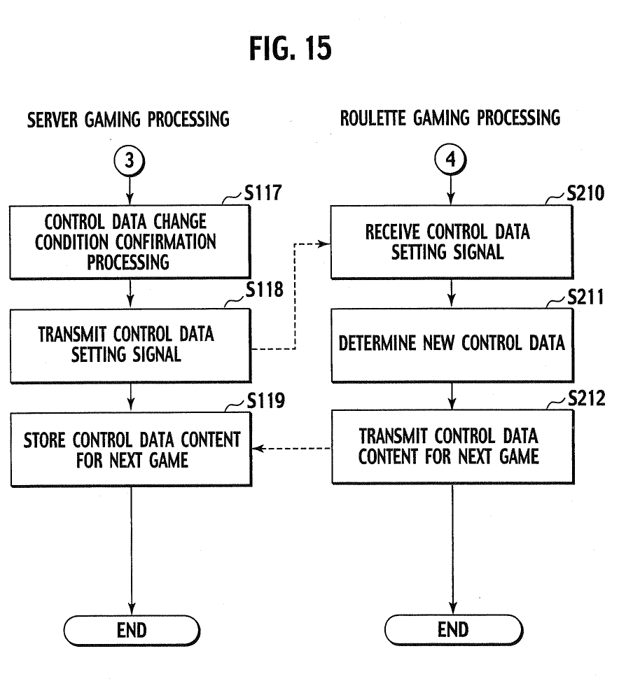

Next, as shown in FIG. 15, the server CPU 81 executes a confirmation processing for confirming whether the condition for changing the control data 1 to 6 used for the rotation of the roulette wheel 22 and the shooting of the ball 27 has been met or not (step S117). Then, the server CPU 81 transmits the setting signal for requesting the setting the control data 1 to 6 to the CPU 101 of the roulette device 2 (step S118).

Here, specifically, the server CPU 81 judges whether a prescribed time (0-th minute of each hour, in the present embodiment) has passed or not in the confirmation processing of the step S117 for confirming whether the condition for changing the control data 1 to 6 has been met or not. In the case where it is judged that the prescribed time has not passed yet, the server CPU 81 transmits a control signal indicating that the condition for changing is not met to the CPU 101 of the roulette device 2. On the other hand, in the case where it is judged that the prescribed time has already passed, the server CPU 81 transmits a control signal indicating that the condition for changing is met to the CPU 101 of the roulette device 2.

Next, the server CPU 81 receives the control data 1 to 6 to be referred in the next game from the CPU 101 of the roulette device 2 and stores it in the RAM 83 (step S119). After the processing of the step S119, this sub routine is terminated.

Hereinafter, the gaming processing of the roulette device 2 will be described with references to FIGS. 13 to 15.

Firstly, as shown in FIG. 13, the CPU 101 receives the control signal for staring the operation of the roulette device 2 from the server CPU 81 of the server 13 (step S201).

Then, the CPU 101 controls the following operations by referring to the current control data stored in the control data memory areas 102A to 102F of the ROM 102.

The CPU 101 rotates the roulette wheel 22 by driving the wheel driving motor 106 for the motor driving time set in the current control data (step S202).

Then, the CPU 101 detects the detection signal from the pocket position detection circuit 107 when a prescribed time (20 seconds, for example) elapses after the rotation of the roulette wheel 22 is started (step S203: YES). The CPU 101 enters the ball 27 (step S204) when the delay time elapses after the detection signal is detected. At this time, the CPU 101 enters the ball 27 at the initial speed set in the current control data.

Note that the CPU 101 refers to one of the control data previously stored in the RAM 103 as the default data among the control data 1 to 6 stored in the control data memory areas 102A to 102F of the ROM 102, when executing the processing of the steps S202 and S204 immediately after the startup of the roulette game machine 1.

Then, as shown in FIG. 14, the CPU 101 receives the control signal for detecting the pocket from the server CPU 81 of the server 13 (step S205). Thereafter, the CPU 101 judges which number pocket 23 into which the ball 27 has fallen by the ball sensor 105 (step S206). After that, the CPU 101 transmits the detection signal indicating the number pocket 23 into which the ball 27 has fallen to the server CPU 81 of the server 13 (step S207).

Subsequently, the CPU 101 receives the request signal for collecting the ball 27 from the server CPU 81 of the server 13 (step S208). Then, the CPU 101 collects the ball 27 on the roulette wheel 22 by activating the ball collecting device 108 provided beneath the roulette wheel 22 (step S209). The collected ball 27 will be entered onto the roulette wheel 22 again by the ball entering device 104 in the subsequent games.

Next, as shown in FIG. 15, the CPU 101 receives the control data setting signal transmitted from the server CPU 81 of the server 13 (step S210). Then, the CPU 101 determines one of the control data 1 to 6 to be referred in the next game according to the received control data setting signal (step S211).

Herein, in the case where the control data setting signal received at the step S210 indicates that the control data changing condition has been met, the CPU 101 judges that it is necessary to change the control data to be referred in the next game. And the CPU 101 selects the control data different from the current control data. Note that the CPU 101 uses the random number value sampled by the sampling circuit or the like to select one of the control data 1 to 6 to be referred in the next game.

On the other hand, in the case where the control data setting signal received at the step S210 indicates that the changing condition is not met, the CPU 101 judges that it is unnecessary to change the control data to be referred in the next game, and refers to the current control data in the next game without any change.

Then, the CPU 101 transmits the control signal including one of the control data 1 to 6 to be referred in the next game determined at the step S211 to the server CPU 81 of the server 13 (step S212). After the processing of the step S212, this sub routine will be terminated.

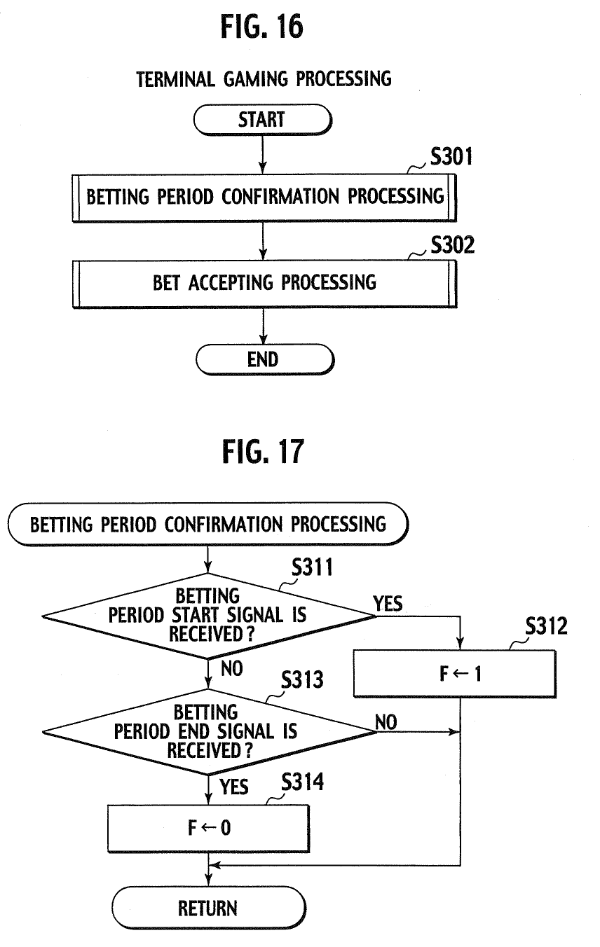

Hereinbelow, the processing executed by the terminal CPU 91 of each gaming terminal 4 of the roulette game machine 1 according to the present embodiment will be described with reference to FIGS. 16 to 19. The terminal CPU 91 executes the processing in accordance with the programs stored in the ROM 92. FIGS. 16 to 19 are flow charts each showing the gaming processing of the gaming terminal of the roulette game machine according to the present embodiment.

Here, the flag F in the RAM 93 is set to “1”, which is default and indicates that it is under the betting period. In addition, the default bet screen 61 (FIG. 6) is displayed on the display 8 of the gaming terminal 4. In this state, as shown in FIG. 16, the terminal CPU 91 firstly executes the betting period confirmation processing (step S301), and then executes the bet accepting processing (step S302).

In the betting period confirmation processing (step S301), as shown in FIG. 17, the terminal CPU 91 confirms whether the betting period start signal has been received from the server CPU 81 or not (step S311) In the case where the betting period start signal has been received (step S311: YES), the terminal CPU 91 sets the flag F in the RAM 93 to “1” which indicates that it is under the betting period (step S312), and then terminates the betting period confirmation processing.

On the other hand, in the case where the betting time start signal has not been received yet (step S311: NO), the terminal CPU 91 confirms whether the betting period end signal has been received from the server CPU 81 or not (step S313). In the case where the betting period end signal has been received (step S313: YES), the terminal CPU 91 sets the flag F in the RAM 93 to “0” which indicates that it is not under the betting period (step S314), and then terminates the betting period confirmation processing. In the case where the betting period end signal has not been received yet (step S313: NO), the terminal CPU 91 terminates the betting period confirmation processing.

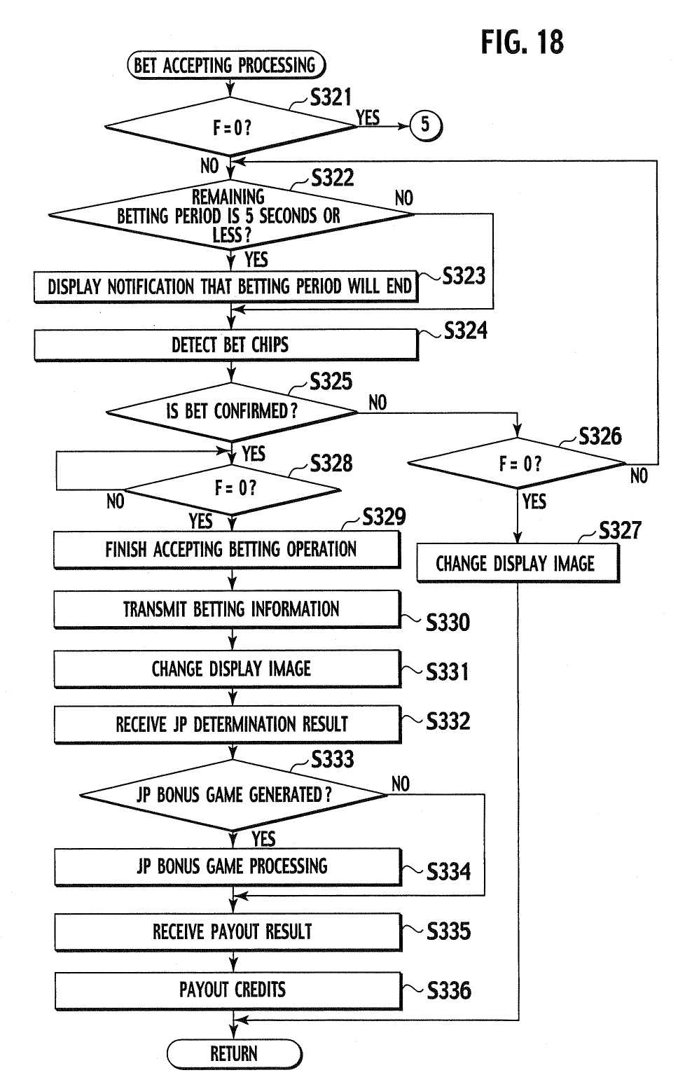

Then, in the bet accepting processing (step S302 in FIG. 16), as shown in FIG. 18, the terminal CPU 91 judges whether the flag F in the RAM 93 is set to “0” or not (step S321). In the case where the flag F is set to “0” (step S321: YES), the terminal CPU 91 shifts the processing to the after-mentioned step S337.

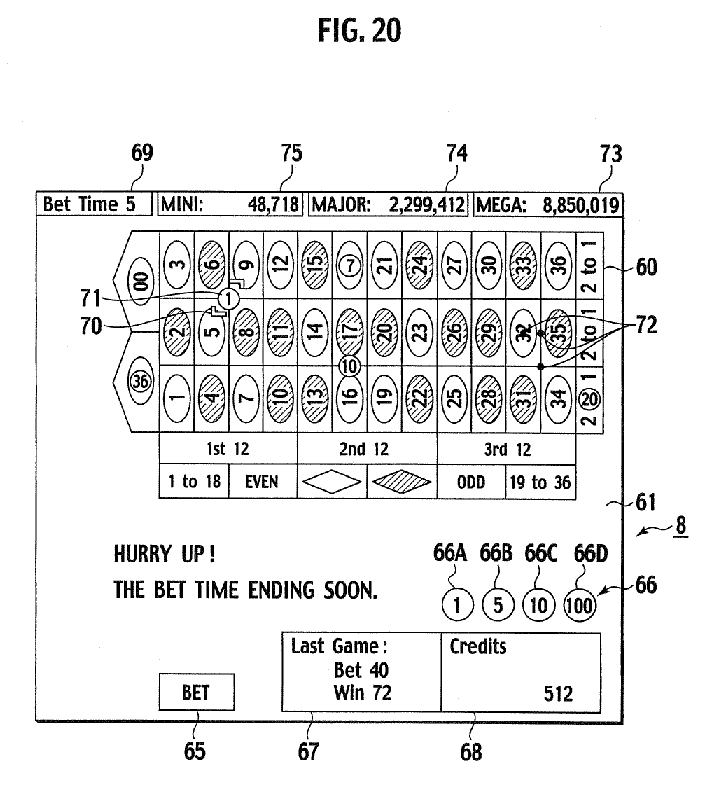

On the other hand, in the case where the flag F is not set to “0” (step S321: NO), the terminal CPU 91 judges whether the remaining betting time has reached the last 5 seconds (“5” or a smaller number is displayed on the bet time counter 69) or not (step S322). In the case where the remaining time has reached the last 5 seconds (step S322: YES), the terminal CPU 91 displays a message “HURRY UP! THE BET TIME ENDING SOON.” on the bet screen 61 as shown in FIG. 20 (step S323), and shifts the processing to the step S324. On the other hand, in the case where the remaining time has not reached the last 5 seconds (step S322: NO), the terminal CPU 91 shifts the processing to the step S324.

The terminal CPU 91 detects the bet placed by the player (step S324). The betting is detected by detecting the player's touches on the bet area 72 in the betting board 60 and on the bet buttons 66 via the touchscreen 50. When the betting is detected, the chip mark 71 is displayed on the specified bet area 72 on the display 8 according to the number of bet chips.

After that, the terminal CPU 91 judges whether the player has confirmed the betting or not (step S325). The betting is confirmed when the player's touch on the bet confirmation button 65 on the display 8 is detected via the touchscreen 50.

In the case where it is judged that the betting has not been confirmed (step S325: NO), the terminal CPU 91 judges whether the flag F in the RAM 93 is set to “0” or not (step S326). In the case where the flag F is not set to “0” (step S326: NO), the terminal CPU 91 returns the processing to the step S322.

On the other hand, in the case where the flag F is set to “0” (step S326: YES), the terminal CPU 91 changes the image on the display 8 (step S327). To be more precise, the terminal CPU 91 firstly switches the image on the display 8 to the image indicating that the betting period has ended, and then switches to the reservation screen 61A shown in FIG. 1. At this time, the betting content having been displayed on the bet screen 61 before the switching is also displayed on the reservation screen 61A without any change after the switching. After the image on the display 8 is switches to the reservation screen 61A, the terminal CPU 91 temporarily stops the betting accepting processing.

In contrast, in the case where it is judged that the player has confirmed the betting (step S325: YES), the terminal CPU 91 judges whether the flag F in the RAM 93 is set to “0” or not (step S328). In the case where the flag F is not set to “0” (step S328: NO), the terminal CPU 91 waits until the judgment result at the step S328 becomes YES.

On the other hand, in the case where the flag F in the RAM 93 is set to “0” (step S328: YES), the terminal CPU 91 finishes accepting betting operations via the touchscreen 50 (step S329). Thereafter, the terminal CPU 91 transmits the betting information of the player (the specified bet area 72, the number of bet chips and the types of betting) to the server CPU 81 (step S330).

Next, the terminal CPU 91 changes the image on the display 8 (step S331). To be more precise, the terminal CPU 91 firstly switches the image on the display 8 to the image indicating that the betting period has ended, and then to the reservation screen 61A (FIG. 1). At this time, the entire betting content having been displayed on the bet screen 61 before the switching is reset (cleared).

Thereafter, the terminal CPU 91 receives the result of the JP determination processing from the server CPU 81 (step S349) similarly as step S332 in FIG. 18. After that, the terminal CPU 91 determines whether to execute the JP bonus game or not, according to the result of the JP determination processing received at the step S347 (step S350) similarly as step S333 in FIG. 18. In the case where it is determined to execute the JP bonus game at its own gaming terminal 4, the terminal CPU 91 executes a prescribed selection-type JP bonus game similarly as step S334 in FIG. 18. And then, the terminal CPU 91 displays the bonus game result (whether the JP has been won or not) in the reservation screen 61A on the display 8 (step S351), according to the determination result received at the step S349.

In the case where it is determined not to execute the JP bonus game at its own gaming terminal 4 at the step S350, or after the step S351, the terminal CPU 91 receives the payout result from the server CPU 81 (step S352) similarly as step S335 in FIG. 18. Note that the payout result includes the payout for the roulette game and the payout for the JP bonus game.

Subsequently, the terminal CPU 91 provides a payout according to the payout result received at the step S352 (step S353) similarly as step S336 in FIG. 18. Thereafter, the terminal CPU 91 temporarily stops the bet accepting processing.

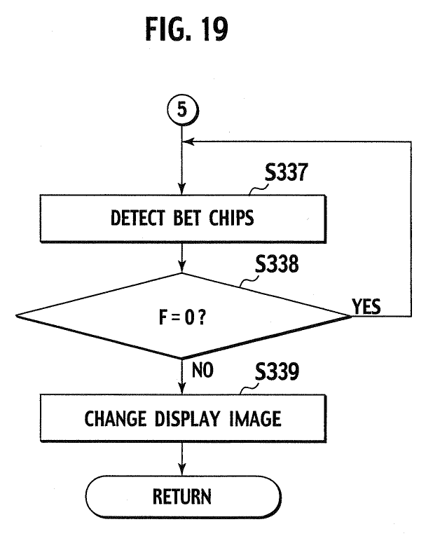

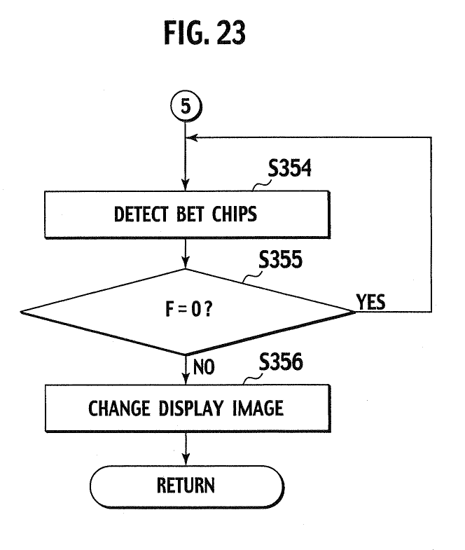

The case where the step S341 is neglected is described with reference to FIG. 23 hereinbelow. In the case where the flag F in the RAM 93 is set to “0” (step S341: YES), as shown in FIG. 23, the terminal CPU 91 detects the betting placed by the player (step S354) similarly as step S337 in FIG. 19. After that, the terminal CPU 91 judges whether the flag F in the RAM 93 is set to “0” or not (step S355) similarly as step S338 in FIG. 19. In the case where the flag F is set to “0” (step S355: YES), the terminal CPU 91 returns the processing to the step S354.

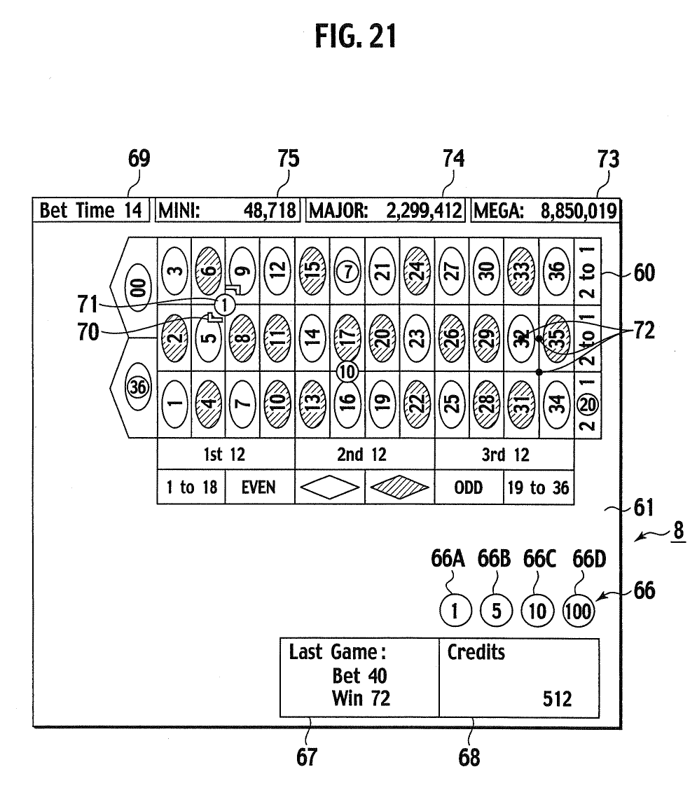

On the other hand, in the case where the flag F is not set to “0” (step S355: NO), the terminal CPU 91 changes the image on the display 8 (step S356) similarly as step S339 in FIG. 19. To be more precise, the terminal CPU 91 firstly switches the image on the display 8 to the image indicating that the betting period has started, and then switches to the bet screen 61 (FIG. 21). At this time, the betting content having been displayed on the reservation screen 61A before the switching is carried over to the bet screen 61 without any change after the switching. After the image on the display 8 is switched to the bet screen 61, the terminal CPU 91 temporarily stops the reservation accepting processing.

Note that the server CPU 81 may execute the processing of the steps S117 to S119 in FIG. 15 at any time, as long as it is after the server CPU 81 receives the betting information from the terminal CPU 91 at the step S107 in FIG. 13.

In addition, the CPU 101 may execute the processing of the steps S210 to S212 in FIG. 15 at any time as long as it is after the CPU 101 receives the control data setting signal, and also it is before the processing of the step S209 in FIG. 14 is executed. However, it is obvious that the timing at which the CUP 101 executes the processing of the steps S210 to S212 in FIG. 15 must be synchronized with the timing at which the server CPU 81 transmits the control data setting signal.

As is clear from the foregoing descriptions, in the roulette game machine 1 according to the first embodiment, the server CPU 81 of the server 13, the terminal CPU 91 of each gaming terminal 4, and the CPU 101 of the roulette device 2 constitute a controller of the present invention.

In the above-described roulette game machine 1 according to the first embodiment of the present invention, the bet screen 61 (FIG. 6) is displayed on the display 8 of each gaming terminal 4 at a time of starting the betting period (for 20 seconds in the present embodiment). Thereafter, the message “HURRY UP! THE BET TIME ENDING SOON.” is additionally displayed in the bet screen 61 when the remaining betting period reaches the last 5 seconds. Then, the message “THE BET TIME FOR THIS GAME ENDED. LET'S BET FOR A NEXT GAME!” is overlapped in the bet screen 61 when the betting period ends. Immediately after this, the image on the display 8 is switched from the bet screen 61 to the reservation screen 61A (FIG. 1). Thereby, the bet reservation period (for 40 seconds in the present embodiment) for the next roulette game is started.

Thereafter, upon completion of the reservation period, the message “THE BET TIME FOR THIS GAME STARTED. LET'S BET FOR A GAME!” is overlapped in the reservation screen 61A on the display 8. Immediately after this, the image on the display 8 is switched from the reservation screen 61A to the bet screen 61 (FIG. 6). Thereby, the betting period for the current roulette game is started.

Then, the player fixes his/her betting content by touching the bet confirmation button 65 before the betting period ends. The betting contents thus fixed is transmitted from each of the gaming terminals 4 to the server 13. The server 13 determines awarding/losing and a payout amount according to the transmitted betting content and the outcome of the roulette game.

Further, in the case where the player does not fix his/her betting content during the betting period, the betting content is carried over to the reservation period for the next roulette game. Accordingly, the chip mark 71 indicating the number of bet chips and the bet area 72, which has not been fixed during the last betting period, is continuously displayed in the reservation screen 61A which is displayed with the completion of the betting period (the start of the reservation period).

Moreover, the betting reservation on the next roulette game can be freely placed during the reservation period without the constraint of the carried-over betting which have not been fixed during the last betting period. But the betting content cannot be fixed during the reservation period. The betting content can be fixed only during the betting period. In addition, the reservation content during the reservation period is carried over to the next betting period without any change. Accordingly, the chip mark 71 which indicates the number of bet chips and the bet area 72 reserved in the last reservation period is continuously displayed in the bet screen 61 displayed after the completion of the reservation period (at the start of the betting period).

Accordingly, in the roulette game machine 1 according to the first embodiment, an inappropriate (improper) period for accepting the betting for the current roulette game which is currently proceeded with the roulette device 2 is excluded from the period where the betting can be fixed. Instead, the betting on the next roulette game can be reserved during the reservation period which is not under the betting period.

In this way, according to the roulette game machine 1 of the first embodiment, new entertainment characteristics can be offered by providing a menu which is different from a menu for participating in the current roulette game. The newly provided menu enables the players to participate in the next roulette game while it is not under the betting period (during the reservation period).

Moreover, in the roulette game machine 1 according to the first embodiment, the betting content that has not been fixed for the current game during the betting period is carried over to the next reservation period without any change. Accordingly, even if the player consider the betting longer than the betting period, the betting content can be fixed at last.

In this way, according to the roulette game machine 1 of the first embodiment, the interest of the player in the game can be enhanced by providing to the player a chance for taking a long time to consider the betting content.

Incidentally, in the roulette game machine 1 according to the first embodiment, the betting content that has not been fixed during the betting period for the current roulette game is carried over to the next reservation period without any change. Alternatively, the betting content during the betting period which has not been fixed by the player may be automatically fixed as the betting content for the current roulette game.

Hereinbelow, descriptions will be provided for a roulette game machine according to a second embodiment of the present invention, which is based on the above alternative case.

The roulette game machine according to the second embodiment of the present invention basically has a hardware configuration similar to that of the first embodiment. For this reason, the foregoing descriptions with reference to FIGS. 1 to 12 and FIG. 20 are incorporated herein for the descriptions of the outward appearance of and the basic configuration inside a roulette game machine according to the second embodiment, and redundant descriptions are omitted here.

In the roulette game machine 1 according to the second embodiment, a bet screen 61 (FIG. 21) displayed during a betting period is the one obtained by removing the bet confirmation button 65 from the bet screen 61 (FIG. 6) of the first embodiment. In this point, the roulette game machine 1 according to the second embodiment has a configuration different from that of the roulette game machine 1 according to the first embodiment.

In addition, the roulette game machine 1 according to the second embodiment of the present invention is different from the roulette game machine 1 according to the first embodiment, in terms of a part of the betting accepting operation executed by a terminal CPU 91 of each gaming terminal 4 in accordance with programs stored in a ROM 92.

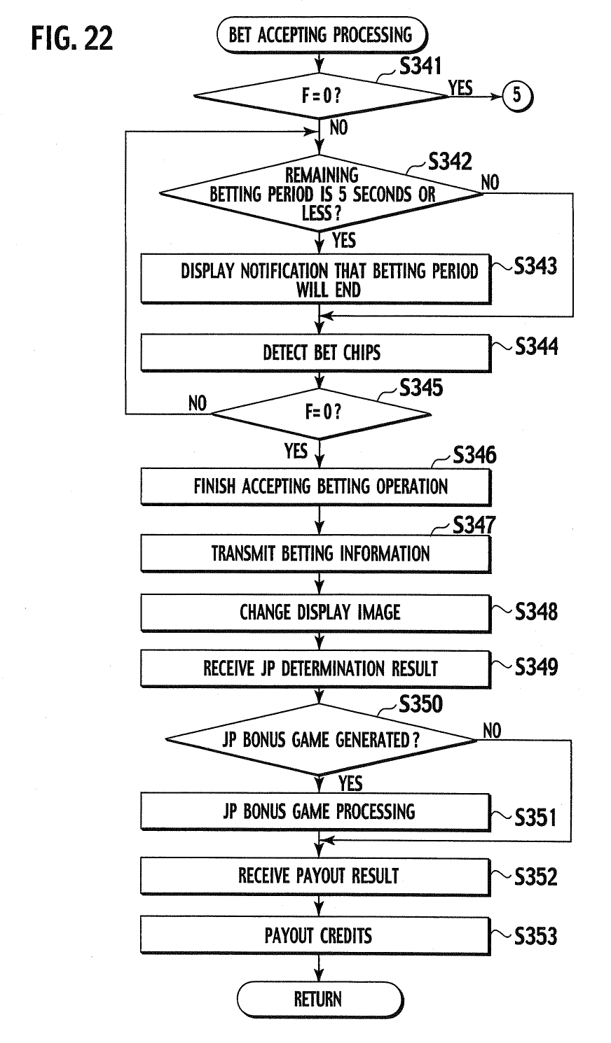

Hereinafter, by referring to FIGS. 22 and 23, descriptions will be provided for the bet accepting processing (different from the processing of the first embodiment) executed by the terminal CPU 91 of the roulette game machine 1 according to the second embodiment of the present invention in accordance with the programs stored in the ROM 92. FIGS. 22 and 23 are flow charts showing the bet accepting processing of the roulette game machine 1 according to the present invention.

First, as shown in FIG. 22, the terminal CPU 91 judges whether the flag F in the RAM 93 is set to “0” or not (step S341) similarly as the step S321 in FIG. 18. In the case where the flag F is set to “0” (step S341: YES), the terminal CPU 91 shifts the processing to the after-mentioned step S354.

On the other hand, in the case where the flag F is not set to “0” (step S341: NO), the terminal CPU 91 judges whether the remaining betting time has reached the last 5 seconds (“5”, or a smaller number is displayed on the bet time counter 69) or not (step S342) similarly as the step S322 in FIG. 18. In the case where the remaining time has reached the last 5 seconds (step S342: YES), the terminal CPU 91 displays a message “HURRY UP! THE BET TIME ENDING SOON.” on the bet screen 61 as shown in FIG. 20 (step S343) similarly as the step S323 in FIG. 18, and shifts the processing to the step S344. On the other hand, in the case where the remaining time has not reached the last 5 seconds (step S342: NO), the terminal CPU 91 shifts the processing to the step S344.

The terminal CPU 91 detects the bet placed by the player (step S344) similarly as the step S324 in FIG. 18. Next, the terminal CPU 91 judges whether the flag F in the RAM 93 is set to “0” or not (step S345) similarly as step S328 in FIG. 18. In the case where the flag F is not set to “0” (step S345: NO), the terminal CPU 91 returns the processing to the step S342.

On the other hand, in the case where the flag F in the RAM 93 is set to “0” (step S345: YES), the terminal CPU 91 finishes accepting betting operations via the touchscreen 50 (step S346) similarly as step S329 in FIG. 18. Thereafter, the terminal CPU 91 transmits the player's betting information which has been made until the end of the betting period (the specified bet area 72, the number of bet chips and the types of betting) to the server CPU 81 (step S347) similarly as step S330 in FIG. 18.

Next, the terminal CPU 91 changes the image on the display 8 (step S348) similarly as step S331 in FIG. 18. To be more precise, the terminal CPU 91 firstly switches the image on the display 8 to the image indicating that the betting period has ended, and then to the reservation screen 61A (FIG. 1). At this time, the entire betting content having been displayed on the bet screen 61 before the switching is reset (cleared).

Thereafter, the terminal CPU 91 receives the result of the JP determination processing from the server CPU 81 (step S332). The result of the JP bonus game determination includes the information which indicates: whether to execute the JP bonus game at any gaming terminal 4 or not; which gaming terminal 4 is to win the JP (or all the gaming terminals 4 are to lose) in the case where it is determined to execute the JP bonus game; and which JP (“MEGA”, “MAJOR” or “MINI”) is to be won in the case of having the JP won.

After that, the terminal CPU 91 determines whether to execute the JP bonus game or not, according to the result of the JP determination processing received at the step S332 (step S333). In the case where it is determined to execute the JP bonus game at its own gaming terminal 4, the terminal CPU 91 executes a prescribed selection-type JP bonus game. And then, the terminal CPU 91 displays the bonus game result (whether the JP has been won or not) in the reservation screen 61A on the display 8 (step S334), according to the determination result received at the step S332.

In the case where it is determined not to execute the JP bonus game at its own gaming terminal 4 at the step S333, or after the step S334, the terminal CPU 91 receives the payout result from the server CPU 81 (step S335). Note that the payout result includes the payout for the roulette game and the payout for the JP bonus game.

Subsequently, the terminal CPU 91 provides a payout according to the payout result received at the step S335 (step S336). Specifically, the terminal CPU 91 stores the credit data of the payout for the roulette game in the RAM 93. And the terminal CPU 91 also stores the accumulated JP credits in the RAM 93 if the JP has been won. Then, when the payout button 5 is touched, the number of medals corresponding to the credits stored in the RAM 93 (usually, one medal per one credit) are paid from the medal payout opening 12. Thereafter, the terminal CPU 91 temporarily stops the bet accepting processing.

The case where the step S321 is neglected is described with reference to FIG. 19 hereinbelow. In the case where the flag F in the RAM 93 is set to “0” (step S321: YES), as shown in FIG. 19, the terminal CPU 91 detects the betting placed by the player (step S337). Here, the betting is detected by detecting the player's touch on the bet area 72 in the betting board 60 and on the bet buttons 66 via the touchscreen 50. When the betting is detected, the chip mark 71 is displayed on the specified bet area 72 on the display 8 according to the number of bet chips.

After that, the terminal CPU 91 judges whether the flag F in the RAM 93 is set to “0” or not (step S338). In the case where the flag F is set to “0” (step S338: YES), the terminal CPU 91 returns the processing to the step S337.

On the other hand, in the case where the flag F is not set to “0” (step S338: NO), the terminal CPU 91 changes the image on the display 8 (step S339). To be more precise, the terminal CPU 91 firstly switches the image on the display 8 to the image indicating that the betting period has started, and then switches to the bet screen 61 (FIG. 6). At this time, the betting content having been displayed on the reservation screen 61A before the switching is carried over to the bet screen 61 without any change after the switching. After the image on the display 8 is switched to the bet screen 61, the terminal CPU 91 temporarily stops the betting accepting processing.

In the above-described roulette game machine 1 according to the second embodiment of the present invention, the bet screen 61 (FIG. 21) is displayed on the display 8 of each gaming terminal 4 at a time of starting the betting period (for 20 seconds in the present embodiment). Thereafter, the message “HURRY UP! THE BET TIME ENDING SOON.” is additionally displayed in the bet screen 61 when the remaining betting period reaches the last 5 seconds. Then, the message “THE BET TIME FOR THIS GAME ENDED. LET'S BET FOR A NEXT GAME!” is overlapped in the bet screen 61 when the betting period ends. Immediately after this, the image on the display 8 is switched from the bet screen 61 to the reservation screen 61A (FIG. 1). Thereby, the bet reservation period (for 40 seconds in the present embodiment) for the next roulette game is started.

Thereafter, upon completion of the reservation period, the message “THE BET TIME FOR THIS GAME STARTED. LET'S BET FOR A GAME!” is overlapped in the reservation screen 61A on the display 8. Immediately after this, the image on the display 8 is switched from the reservation screen 61A to the bet screen 61 (FIG. 21). Thereby, the betting period for the current roulette game is started.

The betting contents during the betting period is transmitted from each of the gaming terminals 4 to the sever 13 as the fixed betting contents. The server 13 determines awarding/losing and a payout amount according to the transmitted betting content and the outcome of the roulette game.

Further, the betting contents during the betting period is reset at the stating time of the reservation period after being automatically fixed. Accordingly, the chip mark 71 indicating the number of bet chips and the bet area 72 is not displayed at all in the reservation screen 61A which is displayed with the completion of the betting period (the start of the reservation period).

And, the betting reservation on the next roulette game can be placed during the reservation period. But the betting content cannot be fixed during the reservation period. The betting content will be automatically fixed at the ending time of the next betting period. In addition, the reservation content during the reservation period is carried over to the next betting period without any change. Accordingly, the chip mark 71 which indicates the number of bet chips and the bet area 72 reserved in the last reservation period is continuously displayed in the bet screen 61 (FIG. 21) displayed after the completion of the reservation period (at the start of the betting period).

Accordingly, in the roulette game machine 1 according to the second embodiment, an inappropriate (improper) period for accepting the betting for the current roulette game which is currently proceeded with the roulette device 2 is excluded from the period where the betting can be fixed. Instead, the betting on the next roulette game can be reserved during the reservation period which is not under the betting period.

In this way, according to the roulette game machine 1 of the second embodiment, new entertainment characteristics can be offered by providing a menu which is different from a menu for participating in the current roulette game. The newly provided menu enables the players to participate in the next roulette game while it is not under the betting period (during the reservation period).

In addition, in the roulette game machine 1 according to the second embodiment of the present invention, the betting content during the betting period for the current roulette game is fixed upon completion of the betting period. Accordingly, the betting content during the betting period doesn't end up in vain, and is fixed as the betting content for the current roulette upon completion of the betting period.

As a result, with the roulette game machine 1 according to the second embodiment of the present invention can capture the player's interest for the game more highly by surely (automatically) fixing the betting content during the betting period as the betting content for the current roulette game.

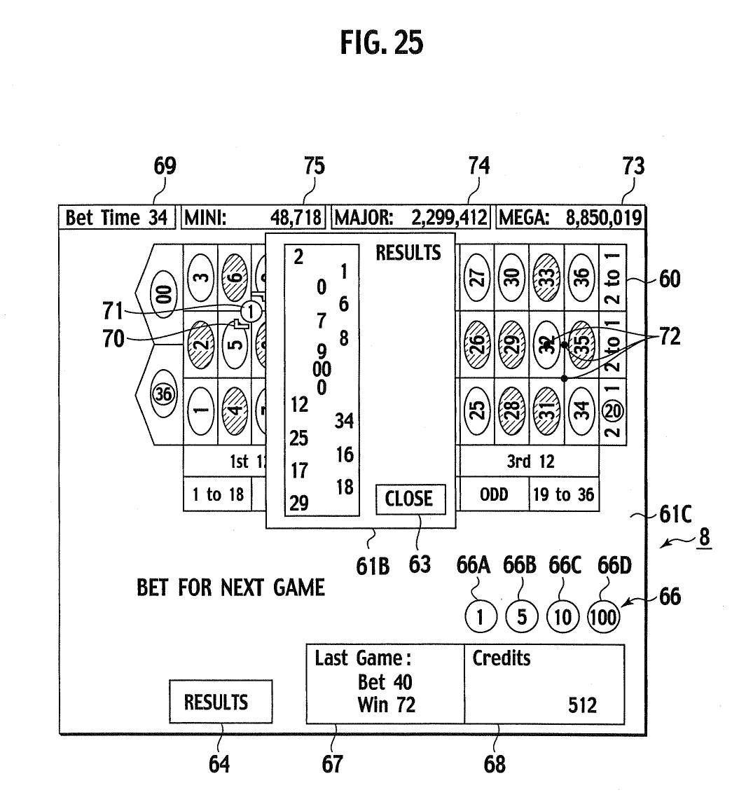

Incidentally, in the first and second embodiments, the reservation screen 61A in FIG. 1 is continuously displayed during the reservation period. However, for example, a history table 61B showing the past game results of a prescribed number of times may be interruptedly displayed during the reservation period, as shown in FIG. 25. FIG. 25 shows one example of the display images of a roulette game machine 1 of a third embodiment of the present invention.

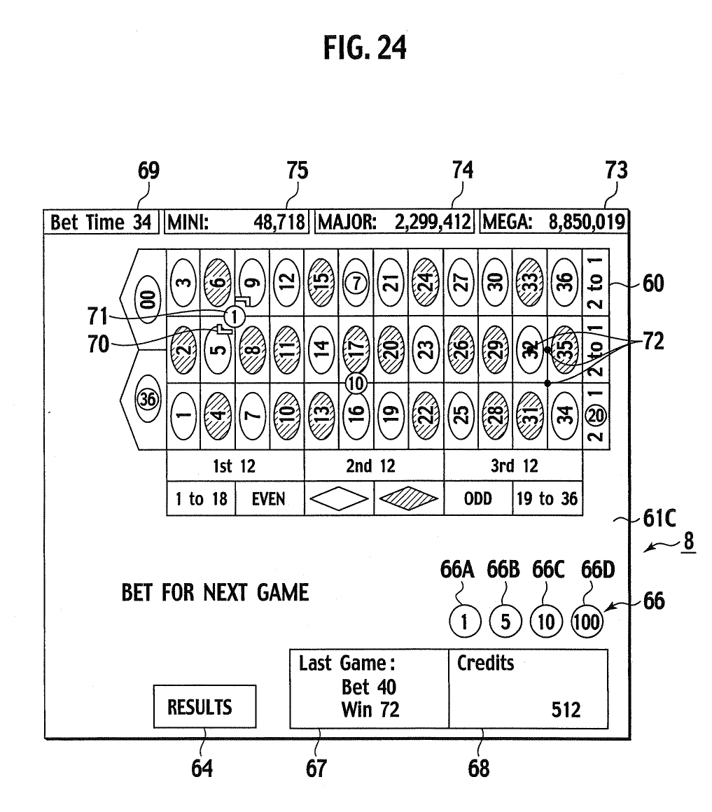

In this embodiment, a reservation screen 61C in FIG. 24 is displayed on the display 8 during the reservation period. In this reservation screen 61C, a results history button 64 is additionally provided on the reservation screen 61A in FIG. 1. When the player touches the results history button 64 during the reservation period, the history table 61B in FIG. 25 is displayed so as to overlap the reservation screen 61C. In this history table 61B, a list of the past game results and a close button 63 are displayed.

In the present embodiment, a list of winning numbers up to the last game is displayed as the game results displayed in the history table 61B, as shown in FIG. 25. Note that, here, one game is defined as a series of operations in which the player places a bet at each gaming terminal 4, the ball 27 falls into one of the number pockets 23, and then a payout is provided based on the winning number. When one game ends, the new wining number is added to the uppermost line of the list. In the present embodiment, up to 16 game results can be listed.

The display of this history table 61B can be automatically terminated after a prescribed time elapses. In this case, the image on the display 8 is returns to the reservation screen 61C in FIG. 24. In addition, even before the prescribed time elapses, the display of the history table 61B may be automatically terminated when the image on the display 8 is switched to the bet screen 61 (FIG. 6) with the completion of the reservation period. Furthermore, the display of the history table 61B can be forced to be terminated with the player's touch on the close button 63 even before the display of the history table 61B is automatically terminated. In this case, the image on the display 8 also returns to the reservation screen 61C in FIG. 24.

Although the embodiments of the present invention have been described hereinabove, the embodiments are only showing specific examples, and do not particularly limit the present invention. Accordingly, the specific configuration of each means or the like can be modified in design appropriately. In addition, the effects described in the embodiments of the present invention are only listing the most preferable effects that can arise from the present invention. For this reason, the effects produced by the present invention are not limited to those described in the embodiments of the present invention.

For example, the foregoing first to third embodiments have been described by taking the roulette game machine 1 as one example. However, the present invention is also applicable to other gaming machines for games such as a bingo game and a slot game, for example.

In addition, it should be considered that the switching timings between the betting period for accepting game media and the reservation period may be different from those described above in the first to third embodiments. For example, in the case where the present invention is applied to a gaming machine for a different type of game from the roulette game described above in the first to third embodiments, the difference between the types of games may lead to the difference between the procedures of the games. For this reason, the switching timings between the betting period for accepting game media and the reservation period must be appropriately set so as to correspond to the procedures of the game to which the present invention is applied. Moreover, even in the case where the present invention is applied to a roulette game, the betting period and the reservation period must be allowed to be switched at timings that differ from those described above in the first to third embodiments within an allowable range for the progress of the game.

Furthermore, the foregoing first to third embodiments have been described by using the case where the roulette device 2 that executes the game operations by itself has the function of a communal display device for displaying the images of the game. However, a device that simply displays the images of the game without executing the game operations may be used as the communal display device of the present invention. For example, in the case of another type of gaming machine for a bingo game, a slot game or the like, it suffices that a communal display device simply display images of the bingo game, the slot game or the like that are generated by the server 13. Examples of such a communal display device include an LCD, a plasma display, a screen projection-type of video projector and the like, for example.

In addition, in the foregoing detail description, the characteristic portions of the present invention have been mainly described in order to make the present invention easily understandable. The present invention is not limited to the embodiments described above in the foregoing detail description, and can be applied to other embodiments, and its applicable range is wide. Moreover, the terms and the terminology used in the present specification are used for the purpose of precisely explaining the present invention, and not used for the purpose of limiting interpretations of the present invention. Further, it should be easy for those skilled in the art to contemplate other configurations, systems, methods, etc., which are included in the concept of the present invention, from the concept of the present invention described in the present specification. For this reason, the description of the appended claims must be construed as containing equivalent configurations within a range of not departing from a range of the technical ideas of the present invention. Moreover, the abstract aims to allow the United States Patent and Trademark Office, general public office, and engineers who are not familiar with a patent, legal terms and technical terms, and who pertain to the technical field of the present invention, to quickly judge the technical content and essence of the present application with a simple study. Accordingly, the abstract is not intended to limit the scope of the invention that should be assessed from the description of the appended claims. Furthermore, it is desirable that the present invention be interpreted by fully taking already-disclosed literatures and the like into consideration in order to fully understand the object of the present invention and unique effects of the present invention.

The forgoing detail descriptions include the processing executed by the computer. The above descriptions and expressions are described in order for those skilled in the art to understand the present invention in the most efficiently. In this specification, each step used for deriving one result should be understood as a processing without a self-contradiction. Moreover, in each step, a transmission, reception, storage, etc., of an electric or magnetic signal is performed. A bit, value, symbol, letter, term, number and the like are used to express such signals in the processing in each step, but it should be noted that these are simply used to make the explanation easy. In addition, the processing at each step is sometimes described in an expression in common with human activities, but the processings described in this specification are principally executed by various types of devices. Furthermore, another configuration required for executing each step is obvious from the foregoing descriptions.

What is claimed is:

1. A gaming machine comprising:
a communal display device for displaying a game which is repeatedly executed;
a gaming terminal at which game media are bet on the game; and
a controller operable to:
(a) execute the game repeatedly,
(b) display the game on the communal display device,
(c) set a betting accepting period during which a bet of the game media on the game can be placed according to status of the game;
(d) close a betting entry by the gaming terminal upon completion of the betting accepting period,
(e) accept the bet which is placed at the gaming terminal before the betting entry is closed as the bet on a current game, and
(f) accept the bet which is placed at the gaming terminal after the betting entry is closed as the bet on a next game.

2. The gaming machine according to claim 1, wherein
the gaming terminal includes a display, and
the controller displays an image for noticing that the betting entry is going to be closed on the display before the betting entry is closed.

3. The gaming machine according to claim 1, wherein
the controller determines the bet which is fixed before the betting entry is closed as the bet on the current game.

4. The gaming machine according to claim 3, wherein
the gaming terminal carries over the bet which is not fixed before the betting entry is closed as the bet on the next game.

5. The gaming machine according to claim 1, wherein
the gaming terminal includes a display, and
the controller is further operable to:
(a) reopen the betting entry upon completion of the game, and
(b) displays history information of past game results on the display in response to a request from the gaming terminal during a period between a closing time point and a reopening time point of the betting entry.

6. A playing method of a gaming machine executing a game repeatedly and displaying the game on a communal display device, comprising:
setting a betting accepting period during which a gaming terminal accepts a bet of game media on the game according to status of the game;
closing a betting entry by the gaming terminal upon completion of the betting accepting period;
accepting the bet which is placed at the gaming terminal before the betting entry is closed as the bet on a current game; and
accepting the bet which is placed at the gaming terminal after the betting entry is closed as the bet on a next game.

7. The playing method of a gaming machine according to claim 6, further comprising:
displaying an image for noticing that the betting entry is going to be closed on a display of the gaming terminal before the betting entry is closed.

8. The playing method of a gaming machine according to claim 6, wherein
the bet which is fixed before the betting entry is closed is determined as the bet on the current game.

9. The playing method of a gaming machine according to claim 8, wherein
the bet which is not fixed before the betting entry is closed is carried over as the bet on the next game.

10. The playing method of a gaming machine according to claim 6, further comprising:
reopening the betting entry upon completion of the game; and
displaying history information of past game results on a display of the gaming terminal in response to a request from the gaming terminal during a period between a closing time point and a reopening time point of the betting entry.
